(19) United States
(12) Patent Application Publication
(10) Pub. No.: US 2010/0280863 A1
(43) Pub. Date: Nov. 4, 2010

(54) Automated Model Generation For Computer Based Business Process

(76) Inventors: Lawrence Wilcock, Wiltshire (GB); Nigel Edwards, Bristol (GB); Sven Graupner, Mountain View, CA (US); Jerome Rolia, Kanata (CA); Bryan Stephenson, Alviso, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/808,227

(22) PCT Filed: Dec. 20, 2007
(86) PCT No.: PCT/US07/88322

§ 371 Date: Jun. 15, 2010

(51) Int. Cl. G06Q 10/00

(52) U.S. Cl. 705/7; 705/348

(57) ABSTRACT

A system for generating a model representing an existing computer based business process involves analysing existing source content (910) which has annotations (920) added, to provide information for the modelling. Static analysis of the annotations can provide some of the information. Other information can be discovered at run time if the annotations alter the run time behaviour to generate monitoring events showing the behaviour. The annotations need not be restricted to codes or symbols or structures of the language of the source content, and can use concepts closer to those in the model being generated. Using annotations rather than manual modelling can reduce errors and lead to better predictions of performance from the model, and result in better reconfiguration of the software or the computing infrastructure to make more efficient usage of shared resources.

### RELATED APPLICATIONS

This application relates to copending US applications of even date titled “MODEL BASED DEPLOYMENT OF COMPUTER BASED BUSINESS PROCESS ON DEDICATED HARDWARE” (applicant reference number 200702144), titled “VISUAL INTERFACE FOR SYSTEM FOR DEPLOYING COMPUTER BASED PROCESS ON SHARED INFRASTRUCTURE” (applicant reference number 200702356), titled “MODELLING COMPUTER BASED BUSINESS PROCESS FOR CUSTOMISATION AND DELIVERY” (applicant reference number 200702363), titled “MODELLING COMPUTER BASED BUSINESS PROCESS AND SIMULATING OPERATION” (applicant reference number 200702377), titled “SETTING UP DEVELOPMENT ENVIRONMENT FOR COMPUTER BASED BUSINESS PROCESS”, (applicant reference number 200702145), and titled “INCORPORATING DEVELOPMENT TOOLS IN SYSTEM FOR DEPLOYING COMPUTER BASED PROCESS ON SHARED INFRASTRUCTURE”, (applicant reference number 200702601), and previously filed US application titled “DERIVING GROUNDED MODEL OF BUSINESS PROCESS SUITABLE FOR AUTOMATIC DEPLOYMENT” (Ser. No. 11/741,878) all of which are hereby incorporated by reference in their entirety.

### FIELD OF THE INVENTION

The invention relates to methods of generating a model representing at least part of a computer based business process having a number of functional steps, from existing source content specifying the functional steps, and from source content of software entities implementing the functional steps, and relates to corresponding systems and software.

### BACKGROUND

Physical IT (information technology) infrastructures are difficult to manage. Changing the network configuration, adding a new machine or storage device are typically complicated and error prone manual tasks. In most physical IT infrastructure, resource utilization is very low: 15% is not an uncommon utilization for a server, 5% for a desktop. To address this, modern computer infrastructures are becoming increasingly (re)-configurable and more use is made of shared infrastructure in the form of data centres provided by service providers.

Hewlett Packard's UDC (Utility Data Centre) is an example which has been applied commercially and allows automatic reconfiguration of physical infrastructure: processing machines such as servers, storage devices such as disks, and networks coupling the parts. Reconfiguration can involve moving or starting software applications, changing allocations of storage space, or changing allocation of processing time to different processes for example. Another way of contributing more reconfigurability, is by allowing many “virtual” computers to be hosted on a single physical machine. The term “virtual” usually means the opposite of real or physical, and is used where there is a level of indirection, or some mediation between the resource user and the physical resource.

In addition some modern computing fabrics allow the underlying hardware to be reconfigured. In once instance the fabric might be configured to provide a number of four-way computers. In another instance it might be re-configured to provide four times as many single processor computers.

It is extremely complex to model the full reconfigurability of the above. Models of higher level entities need to be recursive in the sense of containing or referring to lower level entities used or required to implement them (for example a virtual machine VM, may operate faster or slower depending on what underlying infrastructure is currently used to implement it (for example hardware partition nPAR or virtual partition vPAR, as will be described in more detail below). This means a model needs to expose the underlying configurability of the next generation computer fabrics—an nPAR consists of a particular hardware partition. This makes the models so complex that it becomes increasingly difficult for automated tools (and humans) to understand and process the models, to enable design and management of: a) the business process, b) the application and application configuration, and c) the infrastructure and infrastructure configuration.

The need to model the full reconfigurability and recursive nature of a system is exemplified in the DMTF's profile for “System Virtualization, Partitioning and Clustering”: http://www.dmtf.org/apps/org/workgroup/redundancy/

Another example of difficulties in modelling is WO2004090684 which relates to modeling systems in order to perform processing functions. It says “The potentially large number of components may render the approach impractical. For example, an IT system with all of its hardware components, hosts, switches, routers, desktops, operating systems, applications, business processes, etc. may include millions of objects. It may be difficult to employ any manual or automated method to create a monolithic model of such a large number of components and their relationships. This problem is compounded by the typical dynamic nature of IT systems having frequent adds/moves/changes. Secondly, there is no abstraction or hiding of details, to allow a processing function to focus on the details of a particular set of relevant components while hiding less relevant component details. Thirdly, it may be impractical to perform any processing on the overall system because of the number of components involved.”

There have been attempts to automatically and rapidly provide computing infrastructures: HP's Utility Data Center, HP Lab's SoftUDC, HP's Caveo and Amazon's Elastic Compute Cloud (which can be seen at http://www.amazon.com/gp/browse.html?node=201590011). All of these provide computing infrastructures of one form or another, and some have been targeted at testers and developers, e.g. HP's Utility Data Center.

Aris from IDS-Scheer is a known business process modelling platform having a model repository containing information on the structure and intended behaviour of the system. In particular, the business processes are modelled in detail. It is intended to tie together all aspects of system implementation and documentation.

Aris UML designer is a component of the Aris platform, which combines conventional business process modelling with software development to develop business applications from process analysis to system design. Users access process model data and UML content via a Web browser, thereby enabling processing and change management within a multi-user environment. It can provide for creation and communication of development documentation, and can link object-oriented design and code generation (CASE tools). It relies on human entry of the models.

### SUMMARY OF THE INVENTION

An object is to provide improved apparatus or methods. In one aspect the invention provides:

A method of generating a model representing at least part of a computer based business process having a number of functional steps, from existing source content specifying the functional steps, and from source content of software entities implementing the functional steps, the source content having annotations added, to provide information for modelling, the method having the steps of:

collecting the information provided by the annotations, and
using the information collected by the collector, to generate representations of the functional steps and software entities which implement the functional steps, and arranged to incorporate these representations in the model.

Using annotations for discovering the information about the business process and the software entities implementing the functional steps can enable modelling to be carried out more efficiently and flexibly, as the annotations need not be restricted to codes or symbols or structures of the language of the source content. Hence the annotations can use concepts closer to those in the model being generated. Compared to generating the model manually, less input from scarce skilled humans is needed, and the risk of errors can be reduced, leading to better predictions of performance from the model. This in turn can lead to a better or best configuration of the software or the computing infrastructure, which can lead to more efficient usage of available resources for live deployments, and hence lower costs. This is particularly useful for the common situation where many business processes share the available resources.

Embodiments of the invention can have any additional features, without departing from the scope of the claims, and some such additional features are set out in dependent claims and in embodiments described below.

Another aspect provides software on a machine readable medium which when executed carries out the above method.

Another aspect provides a system for generating a model representing at least part of a computer based business process having a number of functional steps, from existing source content specifying the functional steps, and from source content of software entities implementing the functional steps, the source content having annotations added, to provide information for modelling, the system having: a collector arranged to collect the information provided by the annotations, and a modeller arranged to use the information collected by the collector, to generate representations of the functional steps and software entities which implement the functional steps, and arranged to incorporate these representations in the model.

Other aspects can encompass corresponding steps by human operators using the system, to enable direct infringement or inducing of direct infringement in cases where the infringers system is partly or largely located remotely and outside the jurisdiction covered by the patent, as is feasible with many such systems, yet the human operator is using the system and gaining the benefit, from within the jurisdiction. Other advantages will be apparent to those skilled in the art, particularly over other prior art. Any of the additional features can be combined together, and combined with any of the aspects, as would be apparent to those skilled in the art. The embodiments are examples only, the scope is not limited by these examples, and many other examples can be conceived within the scope of the claims.

### BRIEF DESCRIPTION OF THE FIGURES

Specific embodiments of the invention will now be described, by way of example, with reference to the accompanying Figures, in which:

FIG. 1 shows a schematic view of an embodiment showing models, adaptive infrastructure and a management system,

FIG. 2 shows a schematic view of some operation steps by an operator and by the management system, according to an embodiment,

FIG. 3 shows a schematic view of some of the principal actions and models according to an embodiment,

FIG. 4 shows a schematic view of a sequence of steps from business process to deployed model in the form of a model information flow, MIF, according to another embodiment,

FIG. 5 shows a sequence of steps and models according to another embodiment,

FIG. 6 shows steps in deriving a grounded model according to an embodiment,

FIG. 7 shows an arrangement of master and slave application servers for a distributed design, according to an embodiment,

FIG. 8 shows parts of a master application server for the embodiment of FIG. 7,

FIG. 9 shows an arrangement of virtual entities on a server, for use in an embodiment,

FIG. 10 shows an example of a sales and distribution business process (SD) Benchmark Dialog Steps and Transactions,

FIG. 11 shows an example Custom Model Instance for SD Benchmark,

FIG. 12 shows a class diagram for an Unbound Model Class,

FIG. 13 shows an example of a template suitable for a decentralised SD example,

FIG. 14 shows a Grounded Model instance for a decentralized SD,

FIG. 15 shows another example of a template, suitable for a centralised secure SD example,

FIG. 16 shows an overview of an embodiment of a system for generating a model, based on annotations,

FIG. 17 shows some of the principal steps according to an embodiment,

FIG. 18 shows an embodiment relating to static generation of documentation, automation model, and executable code from annotated source content,

FIG. 19 shows an embodiment relating to run-time generation and modification of documentation and automation models, from run-time model reporting functionality, and

FIGS. 20, 21 and 22 show method steps according to embodiments.

### DESCRIPTION OF SPECIFIC EMBODIMENTS

### Definitions

“Annotation” is intended encompass any extra information added to the source content of any software entity used directly or indirectly by a business process in order to describe the entity in terms of a set of concepts used by a software model of the business process and its associated software components. Annotations may be used by a compiler or other processor of the source content to modify the process of generating executable logic from the source content in order to change the behaviour of that executable logic to allow extraction of the information contained in the annotations.

“non-functional requirements” can encompass how well the functional steps are achieved, in terms such as performance, security properties, cost, availability and others. It is explained in Wikipedia (http://en.wikipedia.org/wiki/Non-functional_requirements) for non-functional requirements as follows—“In systems engineering and requirements engineering, non-functional requirements are requirements which specify criteria that can be used to judge the operation of a system, rather than specific behaviors. This should be contrasted with functional requirements that specify specific behavior or functions. Typical non-functional requirements are reliability, scalability, and cost. Non-functional requirements are often called the ilities of a system. Other terms for non-functional requirements are “constraints”, “quality attributes” and “quality of service requirements”.”

Functional steps can encompass any type of function of the business process, for any purpose, such as interacting with an operator receiving inputs, retrieving stored data, processing data, passing data or commands to other entities, and so on, typically but not necessarily, expressed in human readable form . . . .

“Deployed” is intended to encompass a modelled business process for which the computing infrastructure has been allocated and configured, and the software application components have been installed and configured ready to become operational. According to the context it can also encompass a business process which has started running.

“suitable for automated deployment” can encompass models which provide machine readable information to enable the infrastructure design to be deployed, and to enable the software application components to be installed and configured by a deployment service, either autonomously or with some human input guided by the deployment service.

“business process” is intended to encompass any process involving computer implemented steps and optionally other steps such as human input or input from a sensor or monitor for example, for any type of business purpose such as service oriented applications, for sales and distribution, inventory control, control or scheduling of manufacturing processes, for example. It can also encompass any other process involving computer implemented steps for non business applications such as educational tools, entertainment applications, scientific applications, any type of information processing including batch processing, grid computing, and so on. One or more business process steps can be combined in sequences, loops, recursions and branches to form a complete Business Process. Business process can also encompass business administration processes such as CRM, sales support, inventory management, budgeting, production scheduling and so on, and any other process for commercial or scientific purposes such as modelling climate, modelling structures, or modelling nuclear reactions.

“application components” is intended to encompass any type of software element such as modules, subroutines, code of any amount usable individually or in combinations to implement the computer implemented steps of the business process. It can be data or code that can be manipulated to deliver a business process step (BPStep) such as a transaction or a database table. The Sales and Distribution (SD) product produced by SAP is made up of a number of transactions each having a number of application components for example.

“unbound model” is intended to encompass software specifying in any way, directly or indirectly, at least the application components to be used for each of the computer implemented steps of the business process, without a complete design of the computing infrastructure, and may optionally be used to calculate infrastructure resource demands of the business process, and may optionally be spread across or consist of two or more sub-models. The unbound model can also specify the types or versions of corresponding execution components such as application servers and database servers, needed by each application component, without specifying how many of these are needed for example.

“grounded model” is intended to encompass software specifying in any way, directly or indirectly, at least a complete design of the computing infrastructure suitable for automatic deployment of the business process. It can be a complete specification of a computing infrastructure and the application components to be deployed on the infrastructure.

“bound model” encompasses any model having a binding of the Grounded Model to physical resources. The binding can be in the form of associations between ComputerSystems, Disks, StorageSystems, Networks, NICS that are in the Grounded Model to real physical parts that are available in the actual computing infrastructure. “infrastructure design template” is intended to encompass software of any type which determines design choices by indicating in any way at least some parts of the computing infrastructure, and indicating predetermined relationships between the parts. This will leave a limited number of options to be completed, to create a grounded model. These templates can indicate an allowable range of choices or an allowable range of changes for example. They can determine design choices by having instructions for how to create the grounded model, or how to change an existing grounded model.

“computing infrastructure” is intended to encompass any type of resource such as hardware and software for processing, for storage such as disks or chip memory, and for communications such as networking, and including for example servers, operating systems, virtual entities, and management infrastructure such as monitors, for monitoring hardware, software and applications. All of these can be “designed” in the sense of configuring and/or allocating resources such as processing time or processor hardware configuration or operating system configuration or disk space, and instantiating software or links between the various resources for example. The resources may or may not be shared between multiple business processes. The configuring or allocating of resources can also encompass changing existing configurations or allocations of resources. Computing infrastructure can encompass all physical entities or all virtualized entities, or a mixture of virtualized entities, physical entities for hosting the virtualized entities and physical entities for running the software application components without a virtualized layer.

“parts of the computing infrastructure” is intended to encompass parts such as servers, disks, networking hardware and software for example.

“server” can mean a hardware processor for running application software such as services available to external clients, or a software element forming a virtual server able to be hosted by a hosting entity such as another server, and ultimately hosted by a hardware processor.

“AIService” is an information service that users consume. It implements a business process.

“Application Constraints Model” can mean arbitrary constraints on components in the Customized Process, Application Packaging and Component Performance Models. These constraints can be used by tools to generate additional models as the MIF progresses from left to right.

“ApplicationExecutionComponent” is for example a (worker) process, thread or servlet that executes an Application component. An example would be a Dialog Work Process, as provided by SAP.

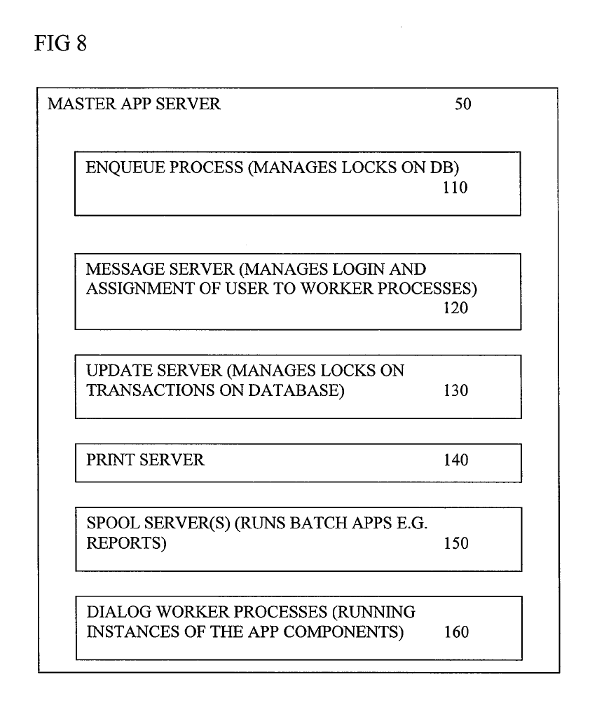

“ApplicationExecutionService” means a service which can manage the execution of ApplicationExecutionComponents such as Work Processes, servlets or data-base processes. An example would be an Application Server as provided by SAP. Such an application server includes the collection of dialog work processes and other processes such as update and enqueue processes as shown in the diagram of the master application server. (FIG. 8).

“Application Packaging Model” is any model which describes the internal structure of the software: what products are needed and what modules are required from the product, and is typically contained by an unbound model.

“Application Performance Model” means any model which has the purpose of defining the resource demands, direct and indirect, for each Business process (BP) step. It can be contained in the unbound model.

“Component Performance Model” can mean any model containing the generic performance characteristics for an Application Component. This can be used to derive the Application Performance Model (which can be contained in the unbound model), by using the specific Business process steps and data characteristics specified in the Custom Model together with constraints specified in the Application Constraints Model.

“Custom Model” means a customized general model of a business process to reflect specific business requirements.

“Deployed Model” means a bound model with the binding information for the management services running in the system.

“Candidate Grounded Model” can be an intermediate model that may be generated by a tool as it transforms the Unbound Model into the Grounded Model.

“Grounded Component” can contain the installation and configuration information for both Grounded Execution Components and Grounded Execution Services, as well as information about policies and start/stop dependencies.

“Grounded Execution Component” can be a representation in the Grounded Model of a (worker) process, thread or servlet that executes an Application Component.

“Grounded Execution Service” is a representation in the Grounded Model of the entity that manages the execution of execution components such as Work Processes, servlets or database processes.

“Infrastructure Capability Model” can be a catalogue of resources that can be configured by the utility such as different computer types and devices such as firewalls and load balancers.

MIF (Model Information Flow) is a collection of models used to manage a business process through its entire lifecycle.

The present invention can be applied to many areas, the embodiments described in detail can only cover some of those areas. It can encompass modeling dynamic or static systems, such as enterprise management systems, networked information technology systems, utility computing systems, systems for managing complex systems such as telecommunications networks, cellular networks, electric power grids, biological systems, medical systems, weather forecasting systems, financial analysis systems, search engines, and so on. The details modelled will generally depend on the use or purpose of the model. So a model of a computer system may represent components such as servers, processors, memory, network links, disks, each of which has associated attributes such as processor speed, storage capacity, disk response time and so on. Relationships between components, such as containment, connectivity, and so on can also be represented.

An object-oriented paradigm can be used, in which the system components are modeled using objects, and relationships between components of the system are modeled either as attributes of an object, or objects themselves. Other paradigms can be used, in which the model focuses on what the system does rather than how it operates, or describes how the system operates. A database paradigm may specify entities and relationships. Formal languages for system modelling include text based DMTF Common InformationModel (CIM), Varilog, NS, C++, C, SQL, or graphically expressed based schemes.

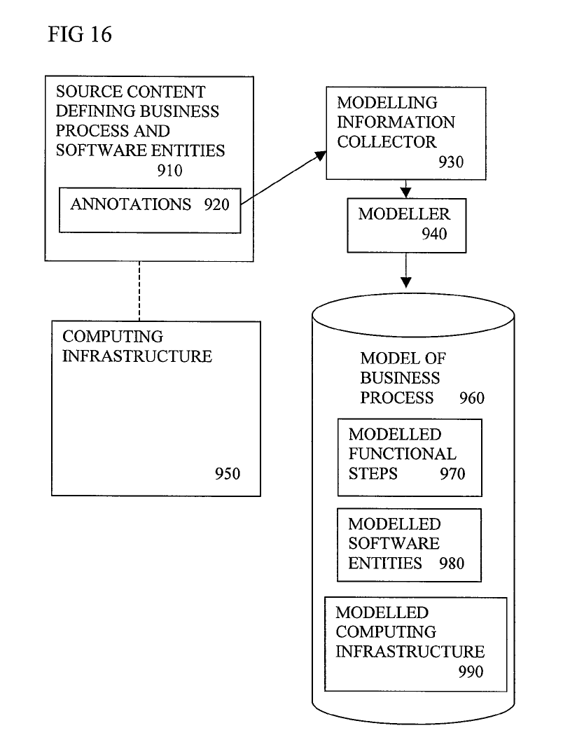

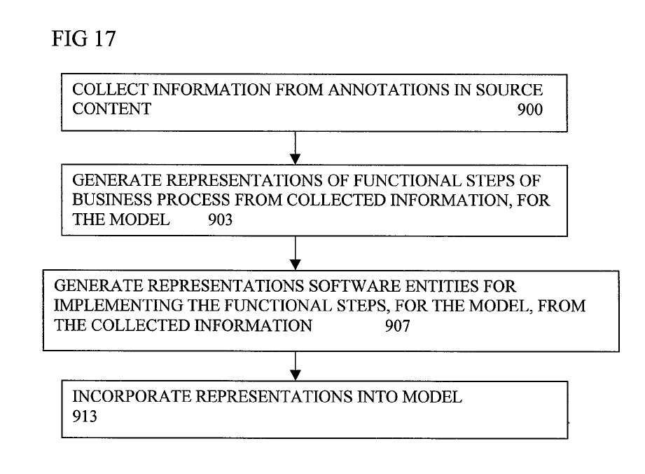

### FIGS. 16 and 17 a First Embodiment

FIGS. 16 and 17 show a first embodiment. FIG. 16 shows an overview of a system for generating a model of an existing business process. The business process runs on computing infrastructure 950, and has source code 910, typically stored elsewhere. There is source code specifying the functional steps of the business process and source code of software entities implementing the functional steps. Annotations 920 are added to the source code. A collector 930 collects the modelling information from the annotations. A modeller 940 is provided for generating parts of the model 960 from the information collected. The model can have modelled functional steps, and modelled software entities 980.

FIG. 17 shows steps of the system of FIG. 16 according to an embodiment of the invention. Information from annotations in source content is collected at step 900. At step 903 the system generates representations of functional steps of the business process from the collected information, for the model. This enables the system to generate representations of software entities for implementing the functional steps, for the model, from the collected information at step 907. These are incorporated into the model at step 913. Steps 903 and 907 could be carried out in the reverse order.

### Additional Features

Some examples of additional features for dependent claims are as follows:

The modeller can be arranged to generate for the model a representation of demands on computing infrastructure by the software entities. This is useful to enable a richer model which can be used in reconfiguring the computing infrastructure to meet the demands more efficiently, or to predict alterations in such demands when reconfiguring the business process or the software entities for example.

At least some of the annotations can be descriptive annotations having statically determinable information identifying the functional steps and software entities for implementing the functional steps, and the collector can be arranged to read the source content to collect the information. This can enable the modeller to model some of the structure of software entities, other than behavioural information such as demands on computing infrastructure which depend on state or usage patterns for example.

The descriptive annotations can use types of entities and types of relationships where the types correspond to types used in the model. This means the descriptions by the descriptive annotations are oriented from the perspective of the model. This can help enable the modeller to generate parts of the model more efficiently. This approach can provide consistency which is particularly useful where the source content is in more than one format.

At least some of the annotations can be monitoring annotations arranged to specify instrumentation points that modify the run-time behaviour of the business process to generate information relating to run-time behaviour, and the collector can be arranged such that at least some of the information collected by the collector is the information relating to run-time behaviour. This can enable richer models to be generated. Not all relationships between business processes and software entities may be known statically and so some can be discovered at run time. For example the set of functional steps (business process steps) in a business process, and their sequence or probability may depend on user behaviour or the state of the system. The use of monitoring annotations for discovering the behaviour can enable the richer modelling to be carried out more efficiently and flexibly, as the annotations need not be restricted to codes or symbols or structures of the language of the source content.

The modeller can be arranged to use the collected run-time behaviour information, to generate a representation of demands on the computing infrastructure by the software entities. This is particularly useful information to enable more complete models which can help make more efficient usage of available computing infrastructure.

The modeller can be arranged to correlate the collected information on run-time behaviour with corresponding representations of software entities and functional steps in the model. This can enable the model to be more complete in modelling behaviour, which can be useful to predict demands on computing infrastructure for example. The information generated by the monitoring events can be arranged to contain modelling data contained in the annotations, to help make the correlation easier.

A level of detail of the monitoring of run-time behaviour can be configurable. This can enable the monitoring to be focussed on areas of interest, which is particularly useful for more complex systems which could otherwise generate too much information.

The system can have a documentation generator, arranged to generate human readable documentation relating to the functional steps and the software entities for implementing the functional steps, from the information collected. This can help enable this important task to be carried out more efficiently. Such documentation can be both on the information that can be discovered statically and also information discovered at runtime. For example, it could encompass a report on what functional steps were actually executed and their demands

The model can comprise an unbound model, and a grounded model, the modeller being arranged to generate the unbound model, and the system further having a design service to generate a mapping of logical components of the unbound model on to computing infrastructure, to provide a grounded model of the business process, suitable for automated deployment on the computing infrastructure. This can help exploit some of the advantages of modelling, by providing a way to find a better or best configuration of the software or the mapping to the computing infrastructure, to lead to more efficient usage of available resources for live deployments. The mapping could have for example a mapping of a logical infrastructure component used to host a software component, to a specific type of physical infrastructure. It could be in the form of a template, or alternatively the annotations could contain such information. This could be seen as a refinement of the template, or as an additional set of constraints. It is conceivable to have a complete template included in the annotations. The unbound model or the grounded model can be used to develop and test alternatives to the existing business process in terms of changes to functional steps, software or computing infrastructure, rather than risking untested changes to the existing business process.

The annotations can be in the source content that specifies the business process and the source content of the software entities that implement that business process. Both can be important if the relationship between the two is relevant, such as where some operators are only interested in the sequence of business process steps, and others are interested in the underlying software entities and lower layers.

The service provider could offer to deploy on dedicated hardware local to the enterprise, and yet provide ongoing management by a service provider. Reference is made to above referenced copending application number 200702144 for more details of examples of this. This can increase complexity for the service provider, in which case, the advantages of using annotations as described can become all the more valuable.

Where a 3-D visual interface is provided with a game server to enable multiple developers to work on the same model and see each others changes, developers can navigate complex models more quickly. Reference is made to above referenced copending application number 200702356 for more details of examples of this. As the complexity increases, again the advantages of using annotations as described can become all the more valuable.

Where an enterprise interface is provided to enable the enterprise to customise the non functional requirements independently of each other, then the service provider may be faced with more complex development effort to meet the customised requirements. Reference is made to above referenced copending application number 200702363 for more details of examples of this. Combining this with the use of annotations as described can assist developers in documentation and model generation and help deal with the more complex development effort.

Where the operation of the business process can be simulated or where multiple test deployments can be made in parallel, development can be accelerated. Reference is made to above referenced copending application number 200702377 for more details of examples of this. Combining this with the use of annotations as described can assist developers and enable the advantages of both to be enhanced.

Setting up of a development environment can be facilitated by providing a predetermined mapping of which tools are appropriate for a given development purpose and given part of the model, or by including models of tools to be deployed with the model. Reference is made to above referenced copending application numbers 200702145, and 200702601 for more details of examples of this. Combining this with the use of annotations as described can assist developers further and so enable the advantages of both to be enhanced.

### Model Based Approach

In the embodiments described, annotations are used in various model based approaches. A general aim of these model based approaches is to enable development and management of the business process to provide matched changes to three main layers: the functional steps of the process, the applications used to implement the functional steps of the process, and configuration of the computing infrastructure used by the applications. Such changes are to be carried out automatically by use of appropriate software tools interacting with models modelling the above mentioned parts. Until now there has not been any attempt to link together tools that integrate business process, application and infrastructure management through the entire system lifecycle.

A model-based approach for management of such complex computer based processes will be described. Such models can have structured data models in CIM/UML to model the following three layers:
Infrastructure elements, such as physical machines, VMs, network links.
Application elements, such as Databases, application servers.
Business level elements, such as functional steps of business processes running in the application servers.

A model is an organized collection of elements modelled in UML for example. A goal of some embodiments is to use these data models for the automated on-demand provision of enterprise applications following a Software as a service (SaaS) paradigm.

### Problem Statement

The design of the hardware infrastructure and software landscape for large business processes such as enterprise applications is an extremely complex task, requiring human experts to design the software and hardware landscape. Once the enterprise application has been deployed, there is an ongoing requirement to modify the hardware and software landscape in response to changing workloads and requirements. This manual design task is costly, time-consuming, error-prone, and unresponsive to fast-changing workloads, functional requirements, and non-functional requirements. The embodiments describe mechanisms to automatically create an optimised design for an enterprise application, monitor the running deployed system, and dynamically modify the design to best meet the non-functional requirements. There are two basic inputs to the design process:
Specification of functional requirements. Typically, this is in the form of a set of business steps that the application is to support. These describe what the system is intended to do from the perspective of end users. The specification will specify the set of standard business steps required from a standard catalogue, and any system-specific customisations of these steps. This specification will determine the set of products and optional components that must be included in the design of a suitable software landscape for the enterprise application.
Specification of non-functional requirements. This defines the requirements that the design must meet, such as performance, security, reliability, cost, and maintainability. Examples of performance could include the total and concurrent number of users to be supported, transaction throughput, or response times.

The design process involves the creation of a specification of the hardware and software landscape of the enterprise application that will meet the functional and non-functional requirements described above. This can consist of:
A set of physical hardware resources, selected from an available pool. The infrastructure would consist of computers, memory, disks, networks, storage, and other appliances such as firewalls.
A virtual infrastructure to be deployed onto the physical resources, together with an assigned mapping of virtual infrastructure to physical infrastructure. The virtual infrastructure must be configured in such a way to best take advantage of the physical infrastructure and support the requirements of the software running on it. For example, the amount of virtual memory or priority assigned to a virtual machine.
A selection of appropriately configured software components and services, distributed across the virtual and physical infrastructure. The software must be configured to meet the system specific functional requirements, such as customisations of standard business processes. Additionally, the software must be configured to best make use of the infrastructure it is deployed on, while meeting both the functional and non-functional requirements. Configuration parameters could include the level of threading in a database, the set of internal processes started in an application server, or the amount of memory reserved for use by various internal operations of an application server.

Using Model-Based technologies to automatically design and manage Enterprise applications can offer powerful predictive power, and the capability to automatically design, deploy, modify, monitor, and manage a running system to implement a business process, while minimizing the requirement for human involvement.

The Enterprise application can be modelled at 4 interconnected layers:
Physical Infrastructure
Virtual Infrastructure
Software Landscape, corresponding to software entities such as the above mentioned application elements
Business Processes

This model is called the Enterprise application Model. At each layer, it consists of two sets of models—the Automation Models and the Document Models.
The Automation Models describe the structure and behaviour of the System, and are used to automatically generate, evaluate, deploy, and modify designs for Enterprise applications. Monitored data from the deployed physical system at each of the 4 layers can be correlated with modelled behaviour and used to make run-time management decisions based on actual measurements.

The Automation Models consist of those models described in the MIF (Business Process Model, Custom Model, Unbound Model, Grounded Model, Bound Model, and Deployed Model), that enable the automation of the Enterprise application through its entire lifecycle from design to deployment.

In general, an Automation Model is composed of two categories of sub-models—the Static Model and Operational Model. The Static Model describes the static structure of the system—the selection and configuration options of candidate designs of the Enterprise application. The Operational Model describes the internal structure, run-time operation, and performance demands (such as CPU, memory, disk, or network I/O) of the infrastructure and software. It is these Operational Models that allow simulation and evaluation of how well a candidate design will meet the non-functional requirements of the System.
The Document Model contains information that can be extracted and transformed into a valuable source of documentation of the System. The information that contributes to the Document Model may be closely associated with entities in the Automation Model. This documentation can be used by humans to understand and inspect the structure and operational behaviour of the system, both for functional correctness but also for non-functional behaviour such as performance. The documentation may also be used for training and educational purposes. Examples of documentation include:
UML diagrams of Business Process steps.
Descriptions of the function of Business Objects, their interfaces, and side effects.
UML diagrams of internal static structure of Software Applications, in terms of the constituent software components.
Activity diagrams of the interactions between software components.

The output from Monitoring and Reporting Services could also be classified as a special case of the Document Model, describing the run-time behaviour and performance of the system in human-readable form. Enterprise applications are very complex, and the Models underlying the modelling techniques are correspondingly complex and difficult to create. The Models may change over time as systems are modified, patched and redesigned. Additionally, the models may depend on the actual data and configuration contained within a specific System and the observed behaviour of a running system.

In general, much of the detailed structure and parameters of the required models are too complex and dynamic for human beings to generate by hand in a timely fashion. The problem addressed by this invention is how to automatically generate, at least parts of, the Automation and Document Models. The information in the models must be consistent and correlated—activity in one part of the system must be traceable and correlated with related activities. For example, an activity A may result in a cascade of other activities B, C and D; it is desirable that these relationships can be represented at run-time and captured in the models.

Model-Based technologies to automatically design and manage Enterprise applications—see “Adaptive Infrastructure meets Adaptive Applications”, by Brand et al, published as an external HP Labs Tech Report: http://www.hpl.hp.com/techreports/2007/HPL-2007-138.html and incorporated herein by reference, can provide the capability to automatically design, deploy, modify, monitor, and manage a running System to implement a business process, while minimizing the requirement for human involvement.

The embodiments are concerned with providing a mechanism to automatically generate key aspects of the required Automation Models of an Enterprise application, together with additional Document Models to be used by humans to understand and analyse the system. The embodiments describe adding consistent and correlated annotations, Model Mark-up, to the various forms of Source Content for the software of an Enterprise Application. The annotations can describe the structure of the system from the perspective of the models that are to be generated. The models and annotations can share the same concepts, such as Business Process, Business Process Steps, Business Object, and Software Component. Instances of those concept types are described in the annotations, together with the relationships between them. Information is automatically captured from the annotations to create or supplement the required models, using a combination of both static analysis and run-time discovery.

### Source Content

The software of an Enterprise Application can be described by various kinds of Source Content. Typically the Source Content is owned by the Enterprise Application Vendor, who would also be responsible for adding the Model-Markup annotations. There may be several forms of Source Content such as:
Program Code written in languages such as Java, or ABAP. This code may be created directly by humans, or automatically generated from other Program Models or tools.
Program Models describe an aspect of the system, such as its static structure, or run-time behaviour. Program Models are themselves expressed in some form of mark-up language, such as XML. Examples might be:
State and Action diagrams for the behaviour of software components.
Business Process diagrams describing the set of business process steps.
Structure diagrams describing the static packaging of the software into deployable units, executables and products.

Program Code or Program Models may be generated via tools, such as graphical editors, or directly by humans. The syntax and language used to describe Source Content may vary widely. However the Model Mark-up added as annotations to the Source Content, should have consistent semantics, concepts, and identifiers so the various parts of the system can be correlated and analysed. Despite the single conceptual model, the syntactic mechanisms used to add the Model Mark-up would necessarily vary, to be compatible with each of the forms of Source Content.

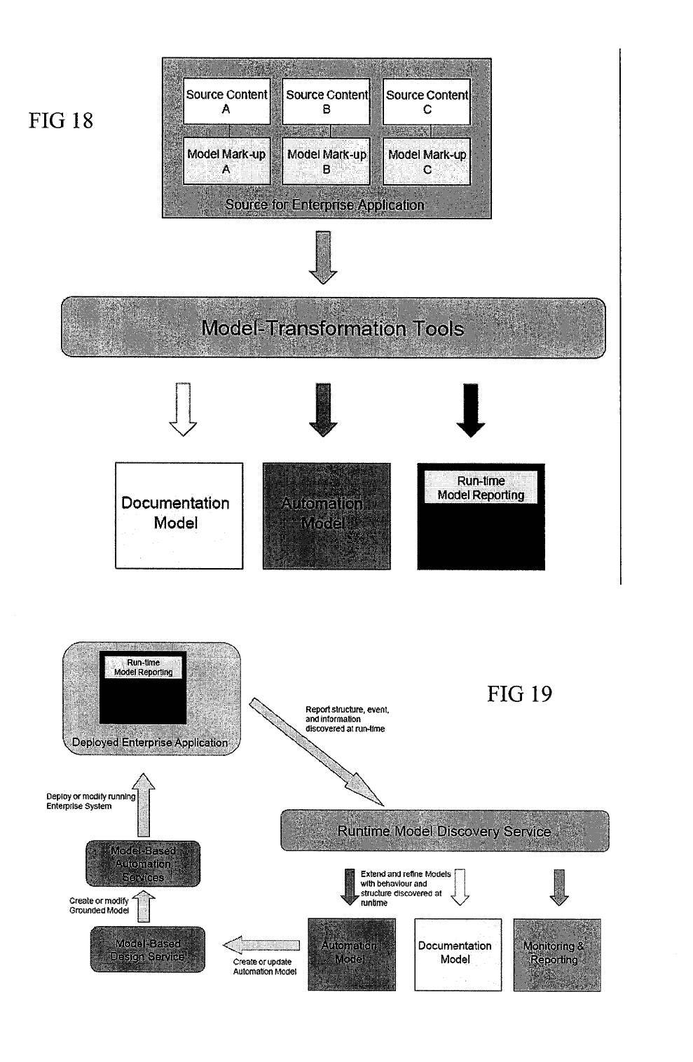

### FIG. 18, Static Analysis

FIG. 18 shows an embodiment of the invention involving static analysis. This figure shows the Source Content of the Enterprise Application, annotated with Model-Markup, and the use of a set of Model-Transformation Tools to generate at least parts of the Document Model, Automation Model, and Executable Code and Data, from a static analysis of the annotations.

This figure shows source content A B and C, and corresponding annotations in the form of model mark up A, B and C. In the static analysis, a set of tools shown as model transformation tools, can extract and transform the Model Mark-up in the Source Content into elements of the Automation and Document Models. For example, this can capture the set of Business Processes and Business Steps in a system, and any statically known invocation relationships between them.

Annotation would be used to add information to various parts of the models in the MIF during static analysis. In particular, the annotation describes information that forms parts of the Unbound Model. Some examples of the use of annotation during static analysis are now given, but should not be considered exhaustive and simply illustrative of the principles.

Annotation in the source content of business processes would describe the business processes and business process steps in the terms of the concepts used by the Business and Custom Models—the set of business processes, how they are composed into business process steps, the invocation relationships between these steps and how the business process steps are implemented as application software components. The relationships between Business Processes and Business Process steps can be described statically where they are known by the designer of the business process or business process step. For example that a business process will always make use of a business process step, or that the execution of one business process step always immediately follows the execution of another business process step. There may be situations where these relationships cannot be described and discovered by static analysis, and must be discovered at run-time via the Run-time Model Reporting functionality. For example a business process step may be generic and able to be used in many business processes, where the execution of the business process step is conditional on the run-time state of the system or human actions.

Similarly, annotation in program code or program models would describe the software structure in terms understood by the Application Packaging Model—the other application components an application component depends on, the software module an application component is part of, the software modules an application component depends on, how software modules are packaged into products, and the software service that executes an application component.

A further feature of some embodiments of the invention is to use the same Model Mark-up for run-time discovery and analysis of the system. This is shown in FIG. 18 as run-time model reporting in the executable code and data. The Markup defines run-time instrumentation points, and the model information to be reported at those points.

### FIG. 19

FIG. 19 shows schematically run-time generation and modification of documentation and automation models, from run-time model reporting functionality. During the static transformation phase, model transformation tools caused instances of the Model-Markup to trigger a transformation of the Source Content to supplement the behaviour of the generated executable code of the Enterprise Application, such that the modified code reports model information to a Model Discovery service. The modified executable code supplements the execution context of the running System with model-based structural information derived from the annotations. This additional context captures the run-time behaviour and interactions between the various parts of the System in terms of the concepts in the required models. The ran-time monitoring generated from the annotation, in some cases with a controllable level of detail, can be used to refine the model and may cause run-time re-evaluation of design choices and therefore the generation of a new grounded model.

Another feature is to use the annotations to relate the modelled concepts with measured performance demands placed on the infrastructure by the Software components, so that the resulting models can ultimately relate the Business Processes to infrastructure requirements.

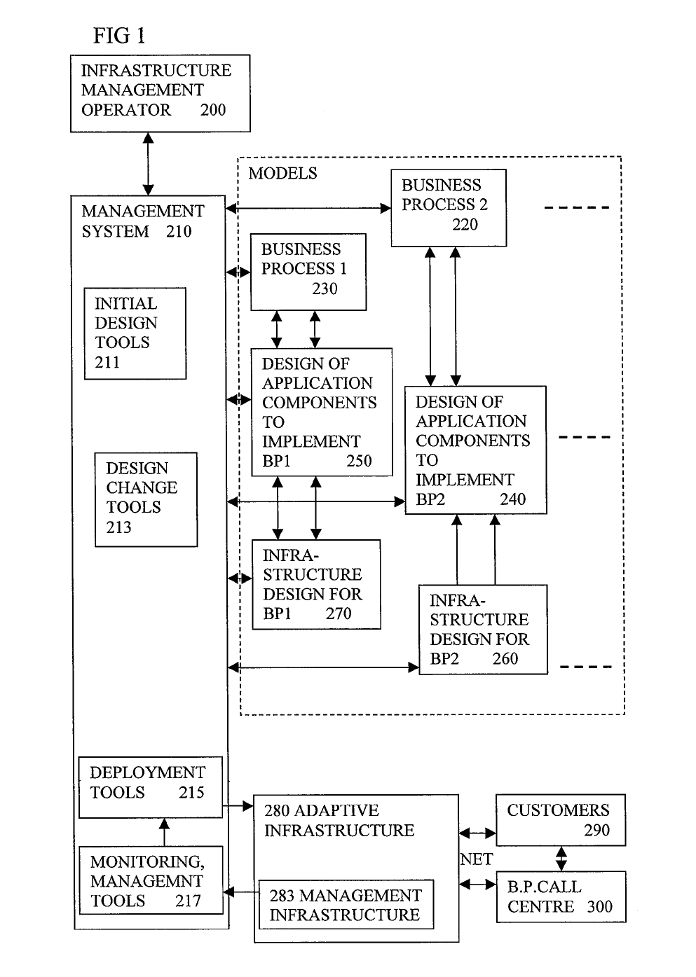

FIG. 19 illustrates model generation at run-time from a deployed System. A sub-set of the Model-Markup results in additional functionality being added to the generated Executable Code—Run-time Model Reporting—used to feed information about the structure and behaviour of the system at run-time to a Model Discovery Service. The Model Discovery Service creates, extends, or modifies both the Automation and Documentation Models based on the reported information. In turn, any modifications to the Automation Model may cause the Model-Based Design Service to re-evaluate the generated Grounded Model for the System, and a new Grounded Model submitted for deployment by the Model-based Automation Services on the available infrastructure. An example of how the model based design service, and model based automation services can be implemented will be described in more detail below with reference to FIGS. 1 to 15. The model discovery service can also be used to generate reports for an operator.

A number of complementary implementation mechanisms are possible for the Run-time Model Reporting functionality, including:
Modification of Source Content—transformation tools analyze the Model-Markup and add or modify the Source Content, to an intermediate form, before it is transformed into the final Executable Code. The tools would insert additional method calls in the Program Code to a make use of a software library to report to the Model Discovery Service. These method calls would be inserted at the points and with the parameters derived from the Model-Markup.
Modified generation of byte code. Instead of modifying the Source Content directly, for example by adding additional function calls, the Model-Markup could be interpreted directly by the compilation tools that generate object-code or byte-code (such as Java byte-code); the generated code would be modified to report information to the Model Discovery Service. The advantage of this technique is that it may be possible to better instrument the details of the execution of the running code. For example to analyse the CPU utilisation, memory consumption (heap and stack size), or live object references in a Java virtual machine, and include these performance demands in the reported information.

For both mechanisms described above for the Run-time Model Reporting functionality, the Model-Markup explicitly triggers modification of the Source Content or byte code at a specific point in the Source Code. Additionally, the transformation tools may analyse the Source Content directly, for example to put wrappers or traps around significant collections of method calls, such as a specific source file; in this case, the Model-Markup may simply modify this process, for example by specifying the level-of-detail, or naming specific parameters for special reporting treatment.

A feature of some embodiments of the invention is that the level-of-detail or sub-set of information gathered and reported from the generated Run-time Model Reporting is configurable, either statically at generation time or dynamically at run-time. For example level-of-detail for reporting could be for:
A thread that executes within an Application Server.
Specific methods of a business object.
All uses of a business object.
A functional unit (collection of related business objects and business processes).
A specific Enterprise Application such as a Database or Application Server.

The information gathered could be targeted or presented according to views/properties of the architecture or person interested in the information. For example:
Switch on model monitoring for only a specific module such as Sales and Distribution.
Generate correlated run-time performance demands for a specified collection of Business Objects, software components, and virtual machines.

Another feature of some embodiments of the invention is to also use the annotations to relate the modelled concepts with measured performance demands placed on the infrastructure by the Software components, so that the resulting models can ultimately relate the Business Processes to infrastructure requirements. This is achieved by supplementing the execution context captured from information in the Markup with information derived from run-time monitoring of the system. For example, the Model-Markup would denote the start and end of a Business Process Step. It would be possible to associate the measured demands on the part of the system that is executing that step with the step itself (e.g. CPU, memory, network I/O) and with the details of the virtual/physical infrastructure, and incorporate this into the generated models to make future performance predictions.

Annotation would be used to provide input to various parts of the models in the MW during runtime discovery analysis. In particular, the annotation describes information that will form parts of the Unbound Model.

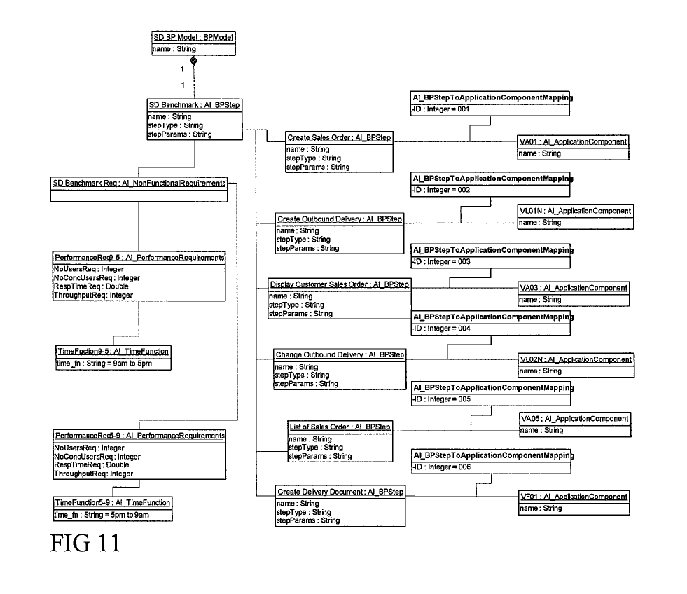

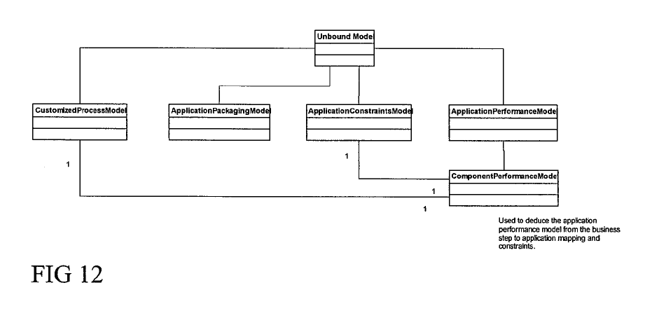

Annotation for Run-time Model Reporting in the source content of business processes allow relationships between business processes and business process steps to be discovered at run-time, where these relationships are not known to the designer of the business processes. For example a business process step may be generic and able to be used in many business processes or the execution of the business process step is conditional on run-time state of the system or human actions, and therefore may be used in business processes that were not predicted by the designer of the business process step. The information about these discovered relationships extend and supplement the Business and Custom Models. Examples are now given of how the Business and Custom Models could be extended and supplemented. These examples should not be considered to be exhaustive, but simply illustrative of the principle. The set of business processes actually used by an organisation, the actual set of business process steps used within that business process, and the invocation ordering between these steps can be discovered at run-time from actual use within the organisation. The detailed invocation relationships between business processes that form part of the Custom Model can be measured, leading to more accurate prediction of the future load on the system based on real user behaviour. For example the actual branching probabilities between business process steps, as users make decisions as they progress through the business process, can be substituted into the Custom Model. Similarly, annotation for Run-time Model Reporting in program code or program models would allow discovery of information and relationships used to extend and supplement the representation of the software structure and performance in terms understood by the Custom Model, Application Packaging Model and Application Performance Model, as shown in FIG. 12 and described in more detail below. This is important because this information depends on the real usage of the system in a specific organisation and is difficult to generalise across all organisations. Some examples will now be given, but these examples should not be considered to be exhaustive, simply illustrative of the principles. In the Custom Model, the Run-time Model Reporting would allow the AI_BPStepToApplicationComponentMapping mapping relationship shown in FIG. 11 between a BPStep and an Application Component to be refined to reflect the real world usage of the Application Component. In the Application Packaging Model, the Run-time Model Reporting would allow the dependency relationships between application components to be refined from discovered actual usage, such as the set of other application components an application component depends on. In the Application Performance Model described below with reference to FIG. 12, the Run-time Model Reporting would allow the invocation relationships between application components and the resource demands to be refined. For example the resource demands such as CPU, memory, network I/O, or disk I/O measured from the monitoring infrastructure would be correlated with the call chain of invocation relationships between Business Process Steps and application components discovered from the Run-time Model Reporting to refine the AI_IndirectComponentResourceDemands and AI_DirectComponentResourceDemands in the Application Performance Model. Additionally, the representation of the call graph between application components in the Application Performance Model could be updated from the discovered information.

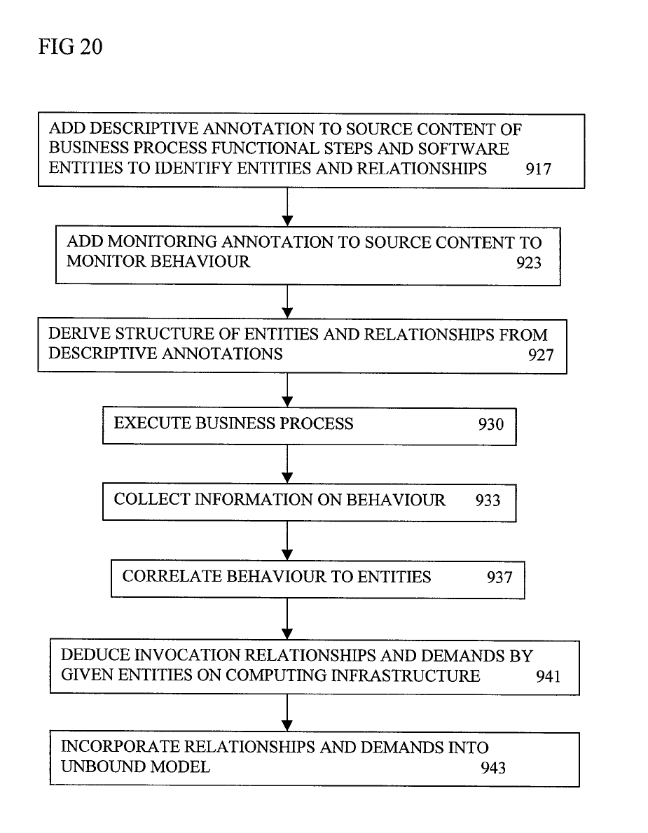

### FIG. 20,

This shows steps carried out by a system according to an embodiment. At step 917, the preliminary step of adding annotation to source content of business process functional steps and software entities to identify entities and relationships is shown. This is typically done manually, though it is conceivable to have software to guide the operator and limit the types of annotations to ensure they are consistent and match the layered structure of the model. The same applies to step 923, the preliminary step of adding monitoring annotation to source content to monitor behaviour. This alters the run time behaviour to generate monitoring events. Examples of this are discussed above. The system can then do the static analysis of deriving a structure of entities and relationships from descriptive annotations, by analysing the source content at step 927. This can be done before or possibly after the run time analysis, as shown at steps 930 to 941. The business process or relevant parts of it, are carried out at step 930. The information on behaviour is collected at step 933, and processed at step 937 to correlate the behaviour to modelled entities. Further processing to deduce invocation relationships and demands by given entities on computing infrastructure is carried out at step 941. Step 943 shows incorporating the discovered relationships and demands into an unbound model of the business process.

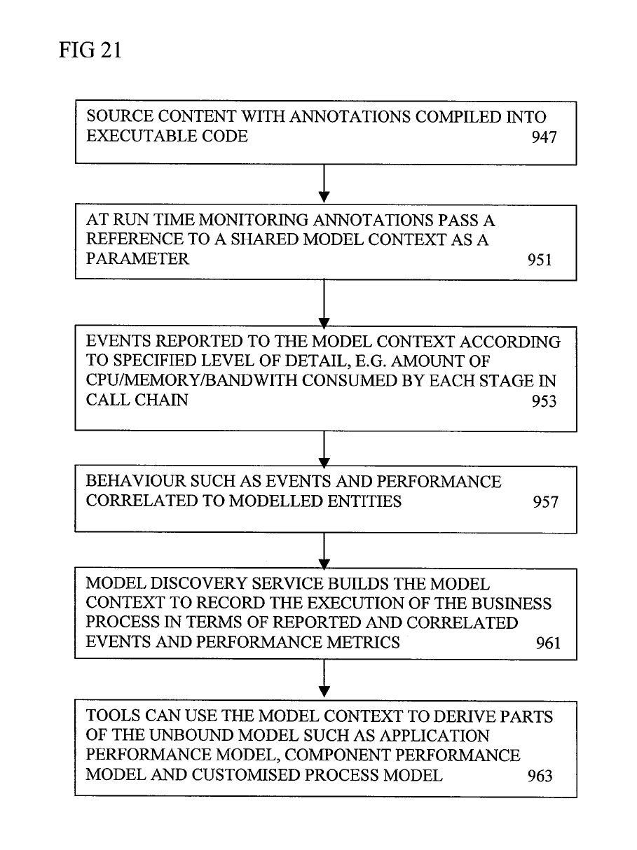

### FIG. 21

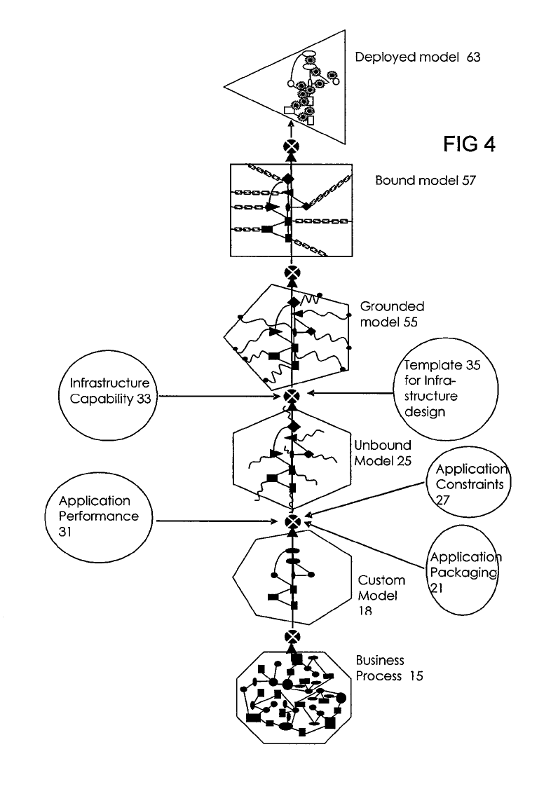

This figure shows steps carried out by a system according to an embodiment, and showing more details of an example of the run time analysis. The source content with annotations is compiled into executable code at step 947 and loaded onto a target machine. At run time, monitoring annotations pass a reference to a shared model context as a parameter at step 951. The Model Context is a shared repository to store and capture information reported by the Run-time Model Reporting during a related sequence of interactions between modelled entities, and identifies a related set of events from the Run-time Model Reporting for a call chain of related interactions of software components. The Model Context could for example be located within the Model Information Collector. The Model Context can store all of the reported model events for a related set of interactions, such as the call graph between application components resulting from the execution of a business process step in a business process. A reference to the Model Context is passed between applications components to maintain the identifier for the related event sequence. This information includes the details of the business process currently executing, the call chain of business process steps, and the invocation relationships between the application components that implement them. As execution passes from one application component to another, information can be added to the generated Run-time Model Reporting events sent to the Model Context about the details of the execution environment of that component—for example, the software execution service executing that component, the host Operating System, and the details of the host hardware. The information in the Model Context can additionally be supplemented with information from other sources that has been correlated with the information discovered from the Run-time Model Reporting. For example information from a monitoring sub-system for resource utilisation measured on the computing infrastructure such as CPU, memory, or disk I/O, could be added to the Model Context for the correlated set of application component interactions. Events are reported to the model context according to specified level of detail, e.g. amount of cpu/memory/bandwith consumed by each stage in call chain at step 953. Behaviour such as events and performance are correlated to modelled entities at step 957. Then the model discovery service can analyse the model context to record the execution of the business process in terms of reported and correlated events and performance metrics, as shown by step 961. At step 963, tools can use the model context to derive parts of the unbound model such as application performance model, component performance model and customised process model. Examples of these parts of the unbound model will be discussed below in more detail with reference to FIG. 4 and other figures.

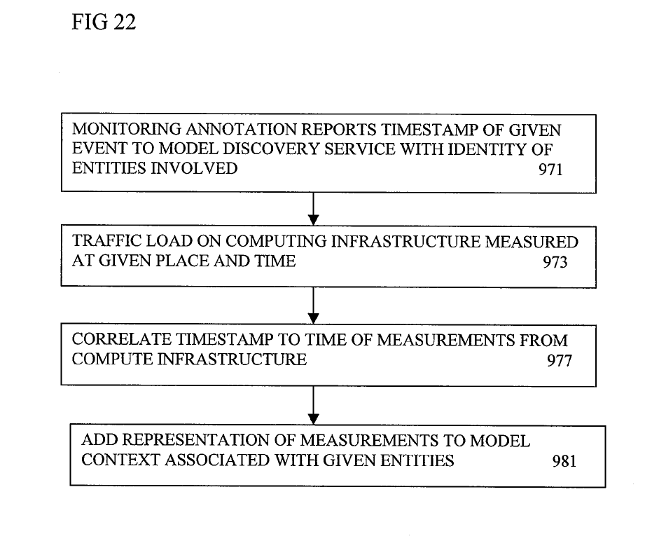

### FIG. 22

FIG. 22 shows steps carried out by a system according to another embodiment, and showing more details of monitoring annotations. In this case, the monitoring annotations are arranged to alter the run time behaviour so as to report a time of events, which can help enable performance to be assessed and modelled more accurately. First the monitoring annotation reports a timestamp of a given event to model discovery service with identity of entities involved at step 971. Then traffic load on computing infrastructure can be measured at given place and time at step 973. At step 981, a representation of these measurements or of a derivation of performance from these measurements, is added to the model context associated with the given entities.

### Outline of Possible Implementation Techniques

Examples will now be given of the kind of annotation that could be added. The examples are not meant to be complete or imply there is only one way of implementing the mechanism—they are simply illustrative of the principles. The annotations are shown in a pseudo XML format. The actual syntax used may be different, to better match the specifics of a particular Source Content type.

The principle is to identify, in the Source Code, instances of the various concepts that will appear in the generated Models of the system that the Source Content implements. For example, Business Process, Business Object, method call, etc. For each annotation instance, the details of that concept instance are given as a set of key-value pairs. Some examples of model concepts are given.

The meta-data associated with a Business Process could be located either in a separate Model-Markup file or embedded in a Source Content file that describes the process. Only one instance would exist for each Business Process. An example could be:

<BusinessProcess>

<name=”Sales and Distribution”>
<id=fah9597wg86> // Unique ID for BusinessProcess
<description=”This is a description of my Business Process”> //
What does it do
<levelOfDetail=high> // Detail of discovery and reporting

</BusinessProcess>

### Example 1

### Annotation of Business Process for Sales and Distribution

The ID field allows other annotation instances to uniquely refer to it. Several mechanisms are possible to associate the Source Content that defines the Business Process with the Business Process annotation. A typical use case might be that a complete Source Content File, describing the process, is tagged with the ID of the process and any resulting code for the process contains the BusinessProcess in its execution context. Alternatively, the tag is associated with only a sub-section of the Source Content file, and only the functionality generated from within that section adds the Business Process to the context passed down the invocation chain.

A Business Process is made up of the invocation of one or more related Business Process Steps. These Business Process Steps are semantically meaningful units of functionality that can be reused in more than one Business Process. The step itself is described in a BusinessProcessStep structure, which like the BusinessProcess, could be embedded in a Source Content file for the step, or be located in a separate mark-up file. Each instance of a Business Process Step annotation would itself have a unique ID.

<BusinessProcesStep>

<name=”Create Sales Order”>
<id=3f87wwoqofo8f8> // ID of the BP step
<bpid= fah9597wg86> // Reference to specific Business Process 1
(known statically)
<bpid= d3i8ffisfug83> // Reference to specific Business Process 2
(known statically)
<description=”Description of this step”
<levelOfDetail=high> // Detail of discovery and reporting

</BusinessProcessStep>

### Example 2

### Annotation of Business Process Step

When the relationship between Business Processes and Business Process Steps is known statically by the designers of the business processes, the relationships can be captured explicitly in the annotation. There are two possible, complementary, mechanisms that would allow tools to easily discover the invocation relationships with a simple static analysis:
The Business Process Step annotation may refer explicitly to the set of Business Processes of which it is a part—this is represented in the set of bpid attributes in Example 2. This would be used when there is a definite intent, by the designer, for the step to be used at least by the specified processes.
Explicit annotation could be added to the Source Content defining the Business Process to mark the invocation points of a Business Process Step—a BusinessProcessStepinvocation annotation would be used for this, simply specifying the ID of the Business Process Step.
   These static annotations do not constrain the use of the Step—if the Step is reusable in many Business Processes, these additional uses would be discovered at run-time by looking at the Business Process Identifier passed down in the context from the invocation in the Business Process. Additionally, the intended use of the steps specified statically in the annotations can be verified at run-time.

The Source Content that results in the implementation of a Business Process Step would contain annotations that describe the behaviour of the step in more detail. These additional annotations within the Source Content describe meaningful operations, or points, within the step, such as start, stop, or external interaction with a third-party system.

<BusinessProcesStepOperation>

<id=3f87wwoqofo8f8> // ID of the BP step
<operation=start> // Start of the business process step
<description=”Description of this step operation”
<levelOfDetail=high> // Detail of discovery and reporting

</BusinessProcessStepOperation>

### Example 3

### Annotation of Business Process Step Operation within a Business Process Step

The implementation of business functionality, in the form of Business Objects (BO) would be described in similar way. There would be a single annotation instance for each type of BO.

<BusinessObject>

<name=”Sales Order”>
<id=yfgf6i7if99hf4d> // Unique ID of the type of BO
<description=”Description of this Business Object”
<levelOfDetail=high> // Detail of discovery and reporting

</ BusinessObject >

### Example 4

### Annotation of Business Object

Within the implementation of a Business Object, each externally visible method would also be annotated. The methods would make reference to the type of Business Object.

<BusinessObjectMethod>

<name=”Create Sales Order”>
<id=5y34lkudhl326236> // Unique ID of the Method
<id=yfgf6i7if99hf4d> // Reference to ID of BO type
<description=”Description of this Business Object Method”
<levelOfDetail=medium> // Detail of discovery and reporting

</ BusinessObjectMethod >

### Example 5

### Annotation of Methods of a Business Object

At run-time a context, the Model Context, would be maintained to collect data from the various annotations to build a picture of the execution of the application. This context would be organised using the structures defined in the Annotation definitions—a set of structured key-value pairs. A reference to the context would be passed as a parameter down the call chain of the generated code, even across machine boundaries. The context itself may be located in a central repository or service, such as the Model Discovery Service. The tools that interpreted the Model-Markup would need to process the Source Content to extend the method signatures of all generated code to reference this shared context. The modified source content would be responsible for appropriately adding or removing data in the Model Context.
method_foo( . . . )->method_foo( . . . , Model_Context contextReference)

### Example 6

### Transformation of Program Code to Pass a Reference to Model Context

The Model Context may contain information not only about the software, but also about the infrastructure it is running on. The infrastructure-related data would include not only the infrastructure that the current call context is miming on, but also the collection of distributed infrastructure that has been involved in the call chain—for example, that the code is running on a Linux virtual machine, on a specific physical machine. Additionally, the execution environment and monitoring infrastructure could supplement the context with information such as amount of CPU/memory/bandwidth consumed by each of the steps and machines in the call chain.

For each reported event from the Run-time Model Reporting functionality, tools could look into the Model Context to discover the structure and run-time behaviour from the perspective of the models—for example which Application Module, Business Process, Business Process Step, Business Object, Business Object Method, etc is involved. The monitored information such as CPU or memory usage produced by the execution environment is also associated with this.

The notion of adding mark-up to the Source Content of software, to direct a transformation that generates either code or documentation, can be implemented using known techniques. An example of document production is the HTML output from Javadoc mark-up embedded in the comments of a Java source file. An example of mark-up affecting the generation of code is the directives embedded in Java classes in the Eclipse Modelling Framework (EMF), which affect the generation of automatically-produced code for model classes for functionality such as instance creation and persistence.

The known model based systems do not try to auto-generate models, or provide the kind of framework for managing relationships as shown in the described embodiments.

Nor do the known systems show that the annotation can drive both static and run-time discovery and analysis of the existing Enterprise business process, to automatically and simultaneously create both a documentation model and a computational model of the system. The resulting computational model can be used to automate the simulation, evaluation, and design of the system.

More details of an example of using a series of models for such purposes will now be described. If starting from scratch, a business process is designed using a business process modeling tool. The business process is selected from a catalog of available business processes and is customized by the business process modeling tool. An available business process is one that can be built and run. There will be corresponding templates for these as described below. Then non-functional characteristics such as reliability and performance requirements are specified.

Next the software entities such as products and components required to implement the business process are selected. This is done typically by searching through a catalog of product models in which the model for each product specifies what business process is implemented. This model is provided by an application expert or the product vendor.

Next the computing infrastructure such as virtual machines, operating systems, and underlying hardware, is designed. This can use templates as described in more detail below, and in above referenced previously filed application Ser. No. 11/741,878 “Using templates in automated model-based system design” incorporated herein by reference. A template is a model that has parameters and options, by filling in the parameters and selecting options a design tool transforms the template into a complete model of a deployable system. This application shows a method of modelling a business process having a number of computer implemented steps using software application components, to enable automatic deployment on a computing infrastructure, the method having the steps of:

automatically deriving a grounded model of the business process from an unbound model of the business process, the unbound model specifying the application components to be used for each of the computer implemented steps of the business process, without a complete design of the computing infrastructure, and the grounded model specifying a complete design of the computing infrastructure suitable for automatic deployment of the business process,
the deriving of the grounded model having the steps of providing an infrastructure design template having predetermined parts of the computing infrastructure, predetermined relationships between the parts, and having a limited number of options to be completed, generating a candidate grounded model by generating a completed candidate infrastructure design based on the infrastructure design template, and generating a candidate configuration of the software application components used by the unbound model, and evaluating the candidate grounded model, to determine if it can be used as the grounded model.

Next the physical resources from the shared resource pool in the data center are identified and allocated. Finally the physical resources are configured and deployed and ongoing management of the system can be carried out.

All of this can use SAP R/3 as an example, but is also applicable to other SAP or non-SAP systems. Templates as discussed below can include not only the components needed to implement the business process and the management components required to manage that business process, but also designs for computing infrastructure.

The model generation part can be implemented in various ways. One way is based on a six stage model flow called the Model Information Flow (MIF). This involves the model being developed in stages or phases which capture the lifecycle of the process from business requirements all the way to a complete running system. The six phases are shown in FIG. 4 described below and each has a corresponding type of model which can be summarised as follows:
General Model: The starting point, for example a high level description of business steps based on “out-of-the-box” functionalities of software packages the user can choose from.
Custom Process Model: defined above, and for example a specialization of the previous model (General Model) with choices made by the enterprise. This model captures non-functional requirements such as response time, throughput and levels of security. Additionally, it can specify modifications to the generic business processes for the enterprise.
Unbound Model: defined above, and for example an abstract logical description of the structure and behaviour of a system capable of running the business process with the requirements as specified by the enterprise.
Grounded Model: defined above and for example can be a transformation of the previous model (Unbound Model) to specify infrastructure choices, such as the quantities and types of hardware and virtualization techniques to use, and also the structure and configuration of the software to run the business process.
Bound Model: a grounded model for which resources in the data centre have been reserved.
Deployed Model: a grounded model where the infrastructure and the software components have been deployed and configured. At this point, the service is up and running.

Each stage of the flow has corresponding types of model which are stored in a Model Repository. Management services consume the models provided by the Model Repository and execute management actions to realize the transitions between phases, to generate the next model in the MIF. Those services can be for example:
Template-based Design Service (TDS) (and an example of a model based design service): translates non-functional requirements into design choices for a Grounded Model based on the template.
Resource Acquisition Service (RAS): its purpose is to allocate physical resources prior to the deployment of virtual resources, such as vms.
Resource Configuration Service (RCS): its role is to create/update the virtual and physical infrastructure.
Software Deployment Service (SDS): installs and configures the applications needed to run the business processes and potentially other software.
Monitoring Services (MS) deploys Probes to monitor behaviour of a Deployed Model. This can include monitoring at any one or more of these three levels:
   Infrastructure: e.g. to monitor CPU, RAM, network I/O usage regardless of which application or functional step is executing.
   Application: e.g. to monitor time taken or CPU consumption of a given application such as a DB process on the operating system, regardless of which particular infrastructure component is used.
   Business process: e.g. count the number of sales order per hour, regardless of which infrastructure components or applications are used.

### Templates for the Computing Infrastructure Design

Templates are used to capture designs that are known to instantiate successfully (using the management services mentioned above). An example of template describes a SAP module running on a Linux virtual machine (vm) with a certain amount of memory. The templates also capture management operations that it is known can be executed, for instance migration of vm of a certain kind, increasing the memory of a vm, deploying additional application server to respond to high load, etc. . . . If a change management service refers to the templates, then the templates can be used to restrict the types of change (deltas) that can be applied to the models.

Templates sometimes have been used in specific tools to restrict choices. Another approach is to use constraints which provide the tool and user more freedom. In this approach constraints or rules are specified that the solution must satisfy. One example might be that there has to be at least one application server and at least one database in the application configuration. These constraints on their own do not reduce the complexity sufficiently for typical business processes, because if there are few constraints, then there are a large number of possible designs (also called a large solution space). If there are a large number of constraints (needed to characterize a solution), then searching and resolving all the constraints is really hard—a huge solution space to explore. Also it will take a long time to find which of the constraints invalidates a given possible design from the large list of constraints.

Templates might also contain instructions for managing change. For example they can contain reconfiguration instructions that need to be issued to the application components to add a new virtual machine with a new slave application server.

The deriving of the grounded model can involve specifying all servers needed for the application components. This is part of the design of the adaptive infrastructure and one of the principal determinants of performance of the deployed business process. The template may limit the number or type of servers, to reduce the number of options, to reduce complexity of finding an optimised solution for example.

The deriving of the grounded model from the unbound Model can involve specifying a mapping of each of the application components to a server. This is part of configuring the application components to suit the design of adaptive infrastructure. The template may limit the range of possible mappings, to reduce the number of options, to reduce complexity for example.

The deriving of the grounded model can involve specifying a configuration of management infrastructure for monitoring of the deployed business process in use. This monitoring can be at one or more different levels, such as monitoring the software application components, or the underlying adaptive infrastructure, such as software operating systems, or processing hardware, storage or communications.

More than one grounded model can be derived, each for deployment of the same business process at different times. This can enable more efficient use of resources for business processes which have time varying demand for those resources for example. Which of the grounded models is deployed at a given time can be switched over any time duration, such as hourly, daily, nightly, weekly, monthly, seasonally and so on. The switching can be at predetermined times, or switching can be arranged according to monitored demand, detected changes in resources such as hardware failures or any other factor.

Where the computing infrastructure has virtualized entities, the deriving of the grounded model can be arranged to specify one or more virtualized entities without indicating how the virtualised entities are hosted. It has now been appreciated that the models and the deriving of them can be simplified by hiding such hosting, since the hosting can involve arbitrary recursion, in the sense of a virtual entity being hosted by another virtual entity, itself hosted by another virtual entity and so on. The template can specify virtual entities, and map application components to such virtual entities, to limit the number of options to be selected, again to reduce complexity. Such templates will be simpler if they do not need to specify the hosting of the virtual entities. The hosting can be defined at some time before deployment, by a separate resource allocation service for example.

The grounded model can be converted to a bound model, by reserving resources in the adaptive infrastructure for deploying the bound model. At this point, the amount of resources needed is known, so it can be more efficient to reserve resources at this time than reserving earlier, though other possibilities can be conceived. If the grounded model is for a change in an existing deployment, the method can have the step of determining differences to the existing deployed model, and reserving only the additional resources needed.

The bound model can be deployed by installing and starting the application components of the bound model. This enables the business process to be used. If the grounded model is for a change in an existing deployment, the differences to the existing deployed model can be determined, and only the additional application components need be installed and started.

Two notable points in the modelling philosophy are the use of templates to present a finite catalogue of resources that can be instantiated, and not exposing the hosting relationship for virtualized resources. Either or both can help reduce the complexity of the models and thus enable more efficient processing of the models for deployment or changing after deployment.

Some embodiments can use an infrastructure capability model to present the possible types of resources that can be provided by a computing fabric. An instance of an infrastructure capability model contains one instance for each type of Computer System or Device that can be deployed and configured by the underlying utility computing fabric. Each time the utility deploys and configures one of these types, the configuration will always be the same. For a Computer System this can mean the following for example.

Same memory, CPU, Operating System

Same number of NICs with same I/O capacity

Same number of disks with the same characteristics

The templates can map the application components to computers, while the range of both application components and computers is allowed to vary. In addition the templates can also include some or all of the network design, including for example whether firewalls and subnets separate the computers in the solution. In embodiments described below in more detail, the Application Packaging Model together with the Custom Process Model show how the various application components can implement the business process, and are packaged within the Grounded Model.

The template selected can also be used to limit changes to the system, such as changes to the business process, changes to the application components, or changes to the infrastructure, or consequential changes from any of these. This can make the ongoing management of the adaptive infrastructure a more tractable computing problem, and therefore allow more automation and thus reduced costs. In some example templates certain properties have a range: for example 0 to n, or 2 to n. A change management tool (or wizard, or set of tools or wizards) only allows changes to be made to the system that are consistent with template. The template is used by this change management tool to compute the set of allowable changes, it only permits allowable changes. This can help avoid the above mentioned difficulties in computing differences between models of current and next state, if there are no templates to limit the otherwise almost infinite numbers of possible configurations. Some of the advantages or consequences of these features are as follows:

1. Simplicity: by using templates it becomes computationally tractable to build a linked tool set to integrate business process, application and infrastructure design and management through the entire lifecycle of design, deployment and change.
2. By limiting the number of possible configurations of the adaptive infrastructure, the particular computing problem of having to compute the differences between earlier and later states of complex models is eased or avoided. This can help enable a management system for the adaptive infrastructure which can determine automatically how to evolve the system from an arbitrary existing state to an arbitrary desired changed state. Instead templates fix the set of allowable changes and are used as configuration for a change management tool.
3. The template models formally relate the business process, application components and infrastructure design. This means that designs, or changes, to any one of these can be made dependent on the others for example, so that designs or changes which are inconsistent with the others are avoided.

### FIG. 1 Overview

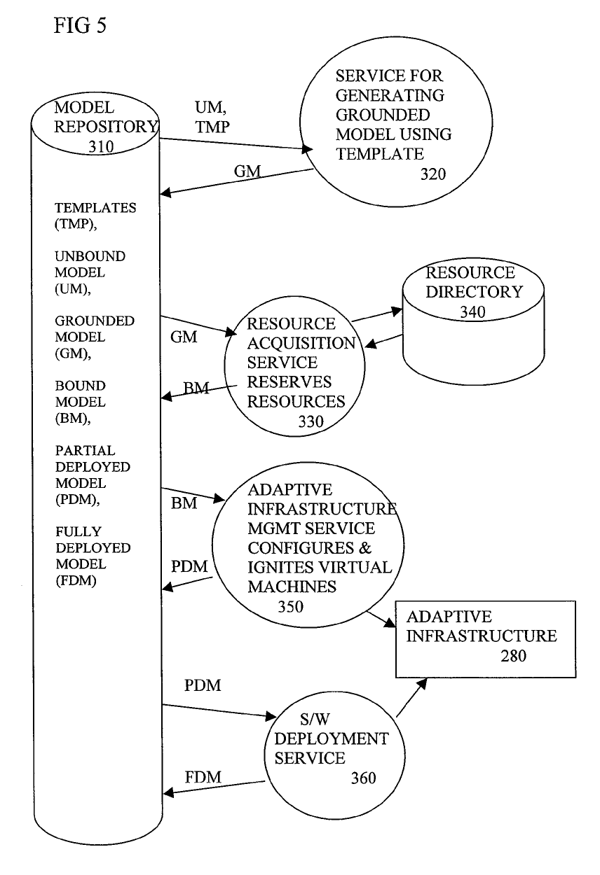

FIG. 1 shows an overview of infrastructure, applications, and management tools and models according to an embodiment. Adaptive infrastructure 280 is coupled typically over the internet to customers 290, optionally via a business process BP call centre 300. A management system 210 has tools and services for managing design and deployment and ongoing changes to deployed business processes, using a number of models. For example as shown, the management system has initial design tools 211, design change tools 213, deployment tools 215, and monitoring and management tools 217. These may be in the form of software tools running on conventional processing hardware, which may be distributed. Examples of initial design tools and design change tools are shown by the services illustrated in FIG. 5 described below. A high level schematic view of some of the models is shown, for two business processes: there can be many more. Typically the management system belongs to a service provider contracted to provide IT services to enterprises who control their own business processes for their customers. A model 230 of business process 1 is used to develop a design 250 of software application components. This is used to create and infrastructure design 270 for running the application components to implement the business process. This design can then be deployed by the management system to run on the actual adaptive infrastructure, where it can be used for example by customers, a call centre and suppliers (not shown for clarity). Similarly, item 220 shows a model of a second business process, used to develop a design 240 of software application components. This is used to create and infrastructure design 260 for running the application components to implement the second business process. This design can then also be deployed by the management system to run on the actual adaptive infrastructure.

The management system has an interface, optionally a 3D visual interface, to an infrastructure management operator 200. This operator can be service provider staff, or in some cases can be trained staff of the enterprise owning the process. The service provider staff may be able to view and manage the processes of different businesses deployed on the shared infrastructure. The operators of a given enterprise would be able to view and manage only their own processes. As discussed above, the interface can be coupled to the management system 210 to be able to interact with the various types of models, and with the infrastructure design template.

The adaptive infrastructure can include management infrastructure 283, for coupling to the monitoring and management tools 217 of the management system. The models need not be held all together in a single repository: in principle they can be stored anywhere.

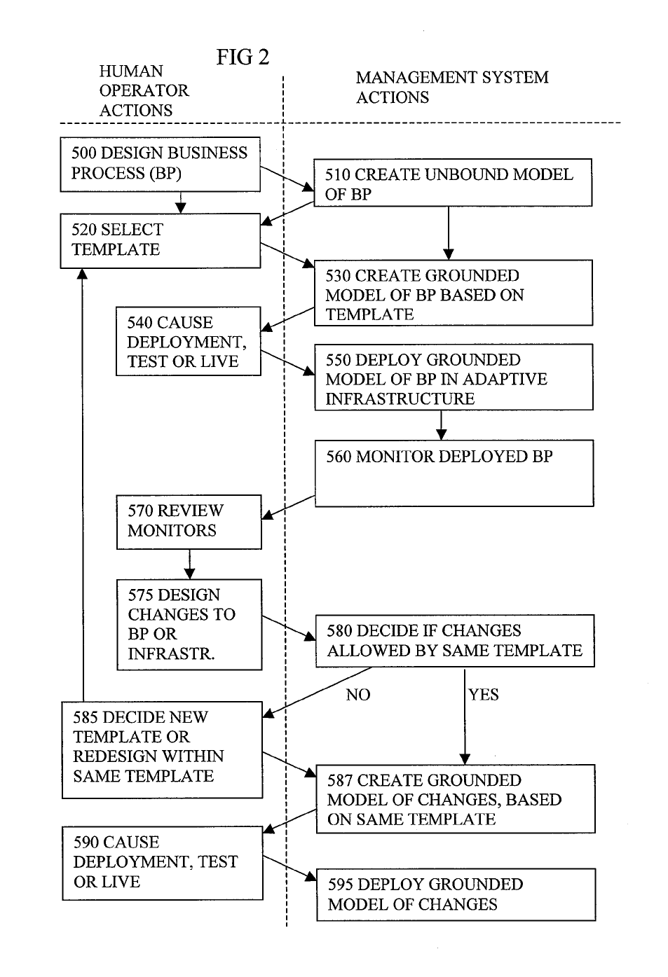

### FIG. 2 Operation

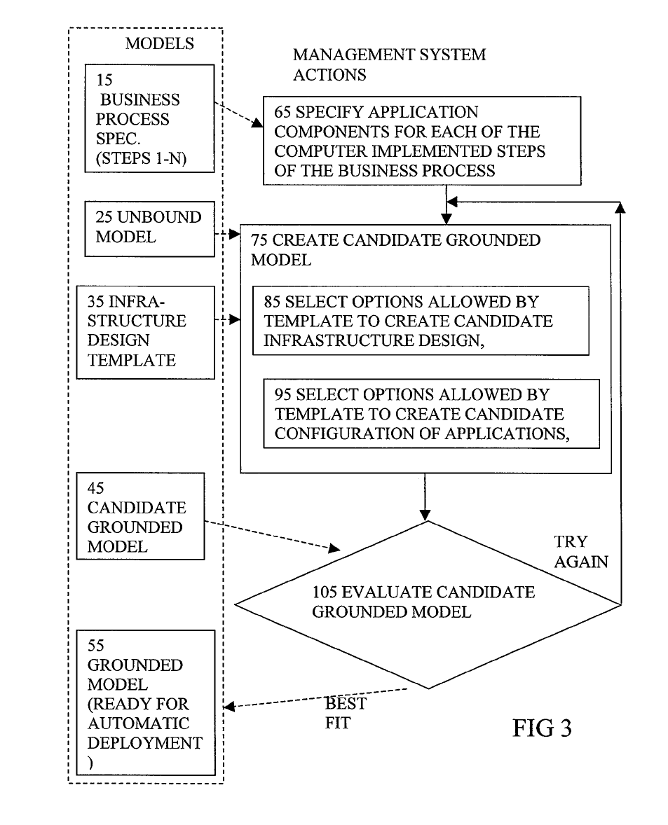

FIG. 2 shows a schematic view of some operation steps by an operator and by the management system, according to an embodiment. Human operator actions are shown in a left hand column, and actions of the management system are shown in the right hand column. At step 500 the human operator designs and inputs a business process (BP). At step 510 the management system creates an unbound model of the BP. At step 520, the operator selects a template for the design of the computing infrastructure. At step 530, the system uses the selected template to create a grounded model of the BP from the unbound model and the selected template. In principle the selection of the template might be automated or guided by the system. The human operator of the service provider then causes the grounded model to be deployed, either as a live business process with real customers, or as a test deployment under controlled or simulated conditions. The suitability of the grounded model can be evaluated before being deployed as a live business process: an example of how to do this is described below with reference to FIG. 3.

At step 550, the system deploys the grounded model of the BP in the adaptive infrastructure. The deployed BP is monitored by a monitoring means of any type, and monitoring results are passed to the human operator. Following review of the monitoring results at step 570, the operator of the enterprise can design changes to the BP or the operator of the service provider can design changes to the infrastructure at step 575. These are input to the system, and at step 580 the system decides if changes are allowed by the same template. If no, at step 585, the operator decides either for a new template, involving a return to step 520, or for a redesign within the limitations of the same template, involving at step 587 the system creating a grounded model of the changes, based on the same template.

At step 590 the operator of the service provider causes deployment of the grounded model for test or live deployment. At step 595 the system deploys the grounded model of the changes. In principle the changes could be derived later, by generating a complete grounded model, and later determining the differences, but this is likely to be more difficult.

### FIG. 3 Operation

FIG. 3 shows an overview of an embodiment showing some of the steps and models involved in taking a business process to automated deployment. These steps can be carried out by the management system of FIG. 1, or can be used in other embodiments.

A business process model 15 has a specification of steps 1-N. There can be many loops and conditional branches for example as is well known. It can be a mixture of human and computer implemented steps, the human input being by customers or suppliers or third parties for example. At step 65, application components are specified for each of the computer implemented steps of the business process. At step 75, a complete design of computing infrastructure is specified automatically, based on an unbound model 25. This can involve at step 85 taking an infrastructure design template 35, and selecting options allowed by the template to create a candidate infrastructure design. This can include design of software and hardware parts. At step 95, a candidate configuration of software application components allowed by the template is created, to fit the candidate infrastructure design. Together these form a candidate grounded model.

At step 105, the candidate grounded model is evaluated. If necessary, further candidate grounded models are created and evaluated. Which of the candidates is a best fit to the requirements of the business process and the available resources is identified. There are many possible ways of evaluating, and many possible criteria, which can be arranged to suit the type of business process. The criteria can be incorporated in the unbound model for example.

There can be several grounded models each for different times or different conditions. For example, time varying non-functional requirements can lead to different physical resources or even a reconfiguration: a VM might have memory removed out-of-office hours because fewer people will be using it. One might even shutdown an underused slave application server VM. The different grounded models would usually but not necessarily come from the same template with different parameters being applied to generate the different grounded models.

The template, grounded and subsequent models can contain configuration information for management infrastructure and instructions for the management infrastructure, for monitoring the business process when deployed. An example is placing monitors in each newly deployed virtual machine which raise alarms when the CPU utilization rises above a certain level—e.g. 60%.

### FIG. 4 MIF

FIG. 4 shows some of the principal elements of the MIF involved in the transition from a custom model to a deployed instance. For simplicity, it does not show the many cycles and iterations that would be involved in a typical application lifecycle—these can be assumed. The general model 15 of the business process is the starting point and it is assumed that a customer or consultant has designed a customized business process. That can be represented in various ways, so a preliminary step in many embodiments is customising it. A custom model 18 is a customization of a general model. So it is likely that a General Model could be modelled using techniques similar to the ones demonstrated for modelling the Custom Model: there would be different business process steps. A custom model differs from the general model in the following respects. It will include non-functional requirements such as number of users, response time, security and availability requirements. In addition it can optionally involve rearranging the business process steps: new branches, new loops, new steps, different/replacement steps, steps involving legacy or external systems.

The custom model is converted to an unbound model 25 with inputs such as application performance 31, application packaging 21, and application constraints 27. The unbound model can specify at least the application components to be used for each of the computer implemented steps of the business process, without a complete design of the computing infrastructure. The unbound model is converted to a grounded model 55 with input from models of infrastructure capability 33, and an infrastructure design template 35.

Deployment of the grounded model can involve conversion to a bound model 57, then conversion of the bound model to a deployed model 63. The bound model can have resources reserved, and the deployed model involves the applications being installed and started.

### FIG. 5 MIF

FIG. 5 shows a sequence of steps and models according to another embodiment. This shows a model repository 310 which can have models such as templates (TMP), an unbound model (UM), a bound model (BM), a partially deployed model (PDM), a fully deployed model (FDM). The figure also shows various services such as a service 320 for generating a grounded model from an unbound model using a template. Another service is a resource acquisition service 330 for reserving resources using a resources directory 340, to create a bound model.

An adaptive infrastructure management service 350 can configure and ignite virtual machines in the adaptive infrastructure 280, according to the bound model, to create a partially deployed model. Finally a software deployment service 360 can be used to take a partially deployed model and install and start application components to start the business process, and create a fully deployed model.

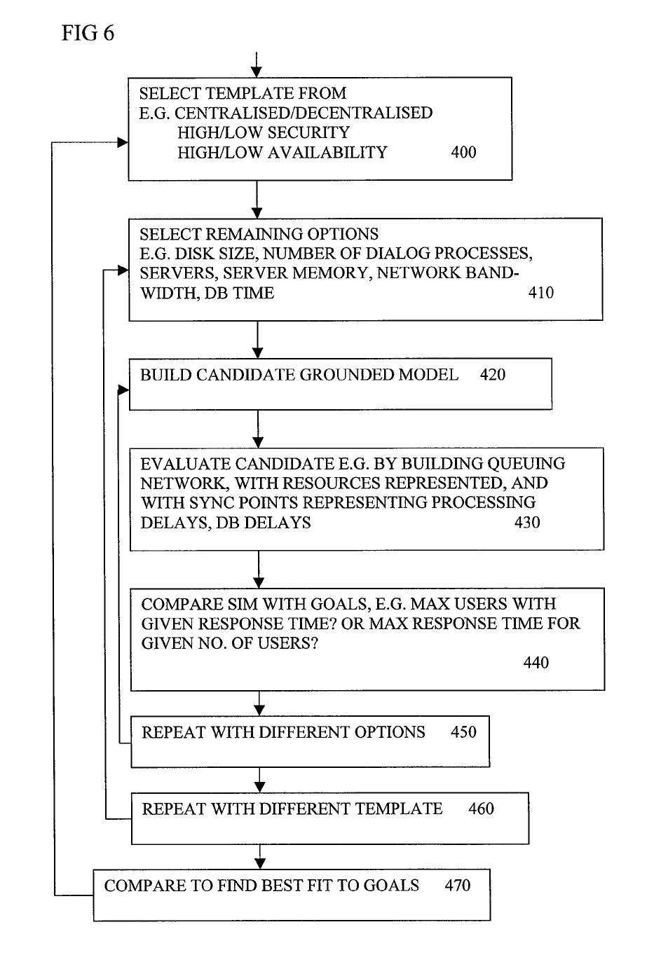

### FIG. 6 Deriving Grounded Model

FIG. 6 shows steps in deriving a grounded model according to an embodiment. At step 400, a template is selected from examples such as centralised or decentralised arrangements. A centralised arrangement implies all is hosted on a single server or virtual server. Other template choices may be for example high or low security, depending for example on what firewalls or other security features are provided. Other template choices may be for example high or low availability, which can imply redundancy being provided for some or all parts.

At step 410, remaining options in the selected template are filled in. This can involve selecting for example disk sizes, numbers of dialog processes, number of servers, server memory, network bandwidth, server memory, network bandwidth, database time allowed and so on. At step 420, a candidate grounded model is created by the selections. Step 430 involves evaluating the candidate grounded model e.g. by building a queuing network, with resources represented, and with sync points representing processing delays, db delays and so on. Alternatively the evaluation can involve deploying the model in an isolated network with simulated inputs and conditions.

At step 440, the evaluation or simulation results are compared with goals for the unbound model. These can be performance goals such as maximum number of simultaneous users with a given response time, or maximum response time, for a given number of users. At step 450, another candidate grounded model can be created and tested with different options allowed by the template. At step 460 the process is repeated for one or more different templates. At step 470, results are compared to identify which candidate or candidates provides the best fit. More than one grounded model may be selected, if for example the goals or requirements are different at different times for example. In this case, the second or subsequent grounded model can be created in the form of changes to the first grounded model.

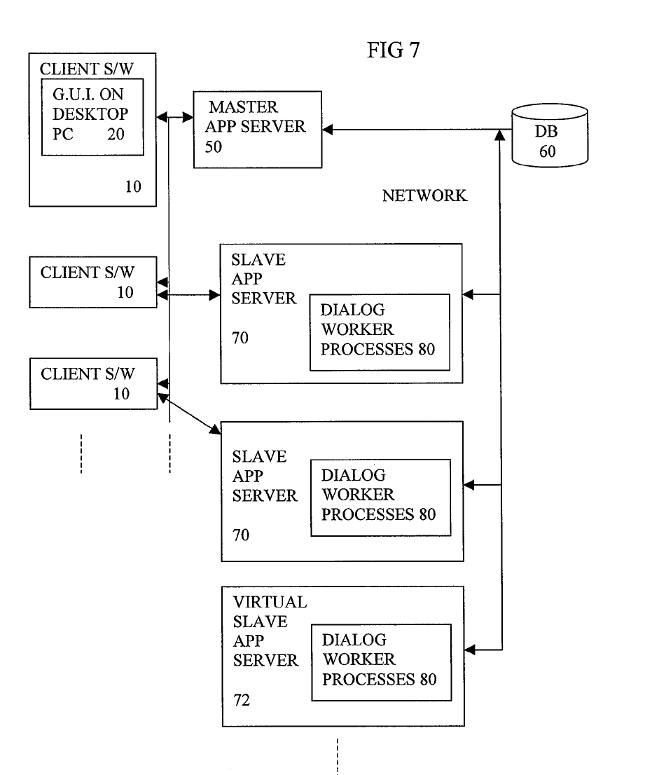

### FIG. 7 Master and Slave Application Servers

FIG. 7 shows an arrangement of master and slave application servers for a decentralised or distributed design of computing infrastructure, according to an embodiment. A master application server 50 is provided coupled by a network to a database 60, and to a number of slave application servers 70. Some of the slaves can be implemented as virtual slave application servers 72. Each slave can have a number of dialog worker processes 80. The master application server is also coupled to remote users using client software 10. These can each have a graphical user interface GUI on a desktop PC 20 coupled over the interne for example. The slaves can be used directly by the clients once the clients have logged on using the master.

### FIG. 8 Master Application Server

FIG. 8 shows parts of a master application server for the embodiment of FIG. 7, An enqueue process 110 is provided to manage locks on the database. A message server 120 is provided to manage login of users and assignment of users to slave application servers for example. An update server 130 is provided for managing committing work to persistent storage in a database. A print server 140 can be provided if needed. A spool server 150 can be provided to run batch tasks such as reports. At 160 dialog worker processes are shown for running instances of the application components.

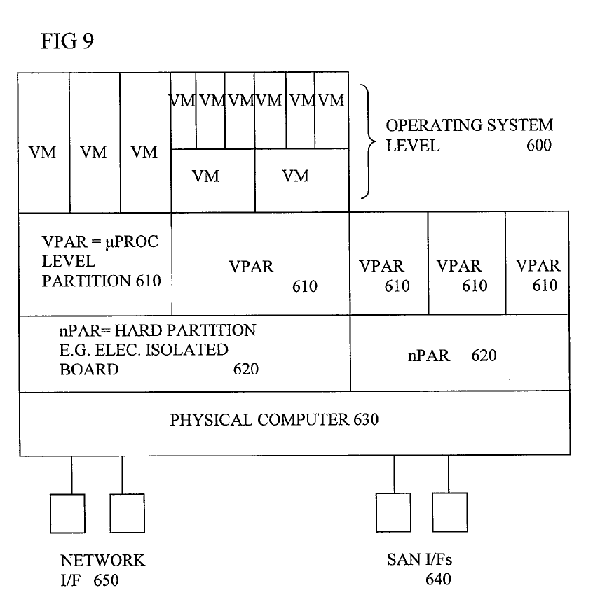

### FIG. 9 Virtual Entities

FIG. 9 shows an arrangement of virtual entities on a server, for use in an embodiment. A hierarchy of virtual entities is shown. At an operating system level there are many virtual machines VM. Some are hosted on other VMs. Some are hosted on virtual partitions VPARs 610 representing a reconfigurable partition of a hardware processing entity, for example by time sharing or by parallel processing circuitry. A number of these may be hosted by a hard partitioned entity nPAR 620 representing for example a circuit board mounting a number of the hardware processing entities. Multiple nPARs make up a physical computer 630 which is typically coupled to a network by network interface 650, and coupled to storage such as via a storage area network SAN interface 640.

There are many commercial storage virtualization products on the market from HP, IBM, EMC and others. These products are focused on managing the storage available to physical machines and increasing the utilization of storage. Virtual machine technology is a known mechanism to run operating system instances on one physical machine independently of other operating system instances. It is known, within a single physical machine, to have two virtual machines connected by a virtual network on this machine. VMware is a known example of virtual machine technology, and can provide isolated environments for different operating system instances running on the same physical machine.

There are also many levels at which virtualization can occur. For example HP's cellular architecture allows a single physical computer to be divided into a number of hard partitions or nPARs. Each nPAR appears to the operating system and applications as a separate physical machine. Similarly each nPAR can be divided into a number of virtual parititions or vPARs and each vPAR can be divided into a number of virtual machines (e.g. HPVM, Xen, VMware).

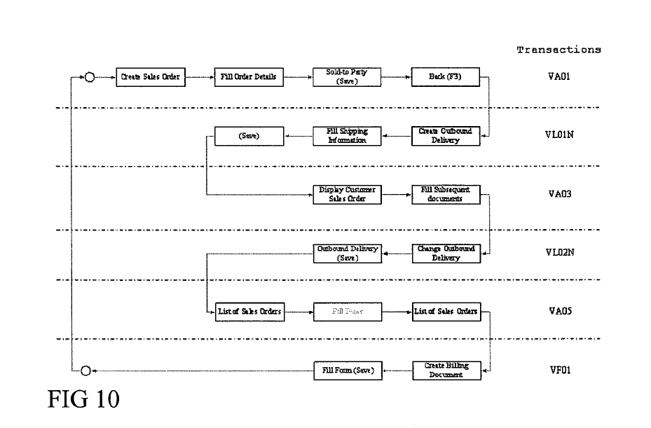

### FIGS. 10 to 15

The next part of this document describes in more detail with reference to FIGS. 10 to 15 examples of models that can be used within the Model Information Flow (MIF) shown in FIGS. 1 to 9, particularly FIG. 4. These models can be used to manage an SAP application or other business process through its entire lifecycle within a utility infrastructure. The diagrams are shown using the well known UML (Unified Modelling Language) that uses a CIM (common information model) style. The implementation can be in Java or other software languages.

A custom model can have a 1-1 correspondence between an instance of an AlService and a BusinessProcess. The AIService is the information service that implements the business process.

A business process can be decomposed into a number of business process steps (BPsteps), so instances of a BusinessProcess class can contain 1 or more BPSteps. An instance of a BPStep may be broken into multiple smaller BPSteps involving sequences, branches, recursions and loops for example. Once the BusinessProcess step is decomposed into sufficient detail, each of the lowest level BPSteps can be matched to an ApplicationComponent. An ApplicationComponent is the program or function that implements the BPStep. For SAP, an example would be the SAP transaction named VA01 in the SD (Sales and Distribution package) of SAP R/3 Enterprise. Another example could be a specific Web Service (running in an Application Server).

BPStep can have stepType and stepParams fields to describe not only execution and branching concepts like higher-level sequences of steps, but also the steps themselves. The stepType field is used to define sequential or parallel execution, loops, and if-then-else statements. The stepParams field is used to define associated data. For example, in the case of a loop, the stepParams field can be the loop count or a termination criterion. The set of BPSteps essentially describes a graph of steps with various controls such as loops, if-then-else statements, branching probabilities, etc.

The relation BPStepsToApplicationComponentMapping is a complex mapping that details how the BPStep is mapped to the ApplicationComponent. It represents, in a condensed form, a potentially complex mix of invocations on an Application Component by the BPStep, such as the specific dialog steps or functions invoked within the ApplicationComponent or set of method calls on a Web Service, and provided details of parameters, such as the average number of line items in a sales order.

A BPStep may have a set of non-functional requirements (NonFunctionalRequirements) associated with it: performance; availability, security, and others. Availability and security requirements could be modelled by a string: “high”, “medium”, “low”. Performance requirements are specified in terms of for example a number of registered users (NoUsersReq), numbers of concurrent users of the system, the response time in seconds and throughput requirement for the number of transactions per second. Many BPSteps may share the same set of non-functional requirements. A time function can be denoted by a string. This specifies when the non-functional requirements apply, so different requirements can apply during office-hours to outside of normal office hours. Richer time varying functions are also possible to capture end of months peaks and the like.

### FIGS. 10, 11 Custom Model

For an example of a Custom Model the well-known Sales and Distribution (SD) Benchmark will be discussed. This is software produced by the well known German company SAP. It is part of the SAP R/3 system, which is a collection of software that performs standard business functions for corporations, such as manufacturing, accounting, financial management, and human resources. The SAP R/3 system is a client server system able to run on virtually any hardware/software platform and able to use many different database management systems. For example it can use an IBM AS/400 server running operating system OS/400 using database system DB2; or a Sun Solaris (a dialect of Unix) using an Oracle database system; or an IBM PC running Windows NT using SQL Server.

SAP R/3 is designed to allow customers to choose their own set of business functions, and to customize to add new database entities or new functionality. The SD Benchmark simulates many concurrent users using the SD (Sales and Distribution) application to assess the performance capabilities of hardware. For each user the interaction consists of 16 separate steps (Dialog Steps) that are repeated over and over. The steps and their mapping to SAP transactions are shown in FIG. 10. A transaction here is an example of an Application Component. Each transaction is shown as a number of boxes in a row. A first box in each row represents a user invoking the transaction e.g. by typing /nva01 to start transaction VA01. As shown in FIG. 10, transaction VA01 in the top row involves the business process steps of invoking the create sales order transaction, then filling order details, then saving the sold-to party, and completing with the “back” function F3 which saves the data. A next transaction VL01N is shown in the second row, and involves steps as follows to create an outbound delivery. The transaction is invoked, shipping information is filled in, and saved. A next transaction VA03 is shown in the third row for displaying a customer sales order. This involves invoking the transaction, and filling subsequent documents. A fourth transaction is VL02N in the fourth row, for changing an outbound delivery. After invoking this transaction, the next box shows saving the outbound delivery. A next transaction shown in the fifth row is VA05, for listing sales orders. After invoking this transaction, the next box shows prompting the user to fill in dates and then a third box shows listing sales orders for the given dates. Finally, in a sixth row, the transaction VF01 is for creating a billing document, and shows filling a form and saving the filled form.

FIG. 11 shows an example of a custom model instance for the SD Benchmark. The two top boxes indicate that the business process “BPModel” contains one top level BPStep: “SD Benchmark”, with stepType=Sequence. Two lines are shown leading from this box, one to the non-functional requirements associated with this top-level BPStep, and shown by the boxes at the left hand side. In this particular case only performance requirements have been specified—one for 9 am-5 pm and the other for 5 pm-9 am. Other types of non-functional requirements not shown could include security or availability requirements for example. In each case the performance requirements such as number of users, number of concurrent users, response time required, and throughput required, can be specified as shown. These are only examples: other requirements can be specified to suit the type of business process. A box representing the respective time function is coupled to each performance requirement box as shown. One indicates 9 am to 5 pm, and the other indicates 5 pm to 9 am in this example.

On the right hand side a line leads from the SD Benchmark BPStep to the functional requirements shown as six BPSteps, with stepType=Step—one for each SAP transaction shown in FIG. 10 (VA01, VL01N, etc). For convenience the name of the first dialog step for each transaction shown in FIG. 10 is used as the name of the corresponding BPStep shown in FIG. 11 (“Create sales order”, “Create outbound delivery”, “Display customer sales order”, “Change outbound delivery”, “List sales order”, and “Create delivery document”). For each of these steps the BPStepToApplicationComponentMapping relation specifies the details of the dialog steps involved. For example in the case of CreateSalesOrder, FIG. 10 shows that the BPStepToApplicationComponentMapping needs to specify the following dialog steps are executed in order: “Create Sales Order”, “Fill Order Details”, “Sold to Party” and “Back”. In addition it might specify the number of line items needed for “Fill Order Details”. At the right hand side of the figure, each BP step is coupled to an instance of its corresponding ApplicationComponent via the respective mapping. So BPstep “Create Sales order” is coupled to ApplicationComponent VA01, via mapping having ID:001. BPstep “Create outbound delivery” is coupled to ApplicationComponent VL01N via mapping having ID:002. BPstep “Display customer sales order” is coupled via mapping having ID:003 to ApplicationComponent VA03. BPstep “Change outbound delivery” is coupled via mapping having ID:004 to ApplicationComponent VL02N. BPstep “List sales order” is coupled via mapping having ID:005 to ApplicationComponent VA05. BPstep “Create delivery document” is coupled via mapping having ID:006 to ApplicationComponent VF01.

### FIG. 12, The Unbound Model

The Unbound Model is used to calculate resource demands. As shown in FIG. 12 this model can be made up of four models: the Custom Model (labelled CustomizedProcessingModel), Application Packaging, Application Constraints and Application Performance models, an example of each of which will be described below (other than the Custom Model, an example of which has been described above with respect to FIG. 11). Other arrangements can be envisaged. No new information is introduced that is not already contained in these four models.

### FIG. 12, Application Packaging Model

The Application Packaging Model describes the internal structure of the software: what products are needed and what modules are required from the product. An ApplicationComponent can be contained in an ApplicationModule. An ApplicationModule might correspond to a JAR (Java archive) file for an application server, or a table in a database. In the case of SAP it might be the module to be loaded from a specific product into an application server such as SD or Fl (Financials). The application packaging model can have a DiskFootPrint to indicate the amount of disk storage required by the ApplicationModule. In the case of the ApplicationComponent VA01 in FIG. 10, it is from SD with a DiskFootPrint of 2 MB for example. One or more ApplicationModules are contained within a product. So for example SAP R/3 Enterprise contains SD. ApplicationModules can be dependent on other ApplicationModules. For example the SD Code for the Application Server depends on both the SD Data and the SD Executable code being loaded into the database. The custom model can have an ApplicationExecutionComponent for executing an ApplicationComponent. This could be a servlet running in an application server or a web server. It could also be a thread of a specific component or a process. In the case of SD's VAO1 transaction it is a Dialog Work Process. When it executes, the ApplicationComponent may indirectly use or invoke other Application-Components to run: a servlet may need to access a database process; SD transactions need to access other ApplicationComponents such as the Enqueue Work Process and the Update Work Process, as well as the Database ApplicationExecutionComponent. The ApplicationExecutionComponent can be contained by and executed in the context of an ApplicationExecutionService (SAP application server) which loads or contains ApplicationModules (SD) and manages the execution of ApplicationExecutionComponents (Dialog WP) which, in turn, execute the ApplicationComponent (VA01) to deliver a BPStep.

### FIG. 12, Application Constraints Model

The Application Constraints Model expresses arbitrary constraints on components in the Customized Process, Application Packaging and Component Performance Models. These constraints are used by tools to generate additional models as the MIF progresses from left to right. Examples of constraints include:
How to scale up an application server—what ApplicationExecutionComponents are replicated and what are not. For example, to scale up an SAP application server to deal with more users one cannot simply replicate the first instance—the master application server 50 of FIGS. 7 and 8, commonly known as the Central Instance. Instead a subset of the components within the Central Instance is needed. This is also an example of design practice: there may be other constraints encoding best design practice.
Installation and configuration information for ApplicationComponents, ApplicationExecutionComponents and ApplicationExecutionServices
Performance constraints on ApplicationExecutionServices—e.g. do not run an application server on a machine with greater than 60% CPU utilization

Other examples of constraints include ordering: the database needs to be started before the application server. Further constraints might be used to encode deployment and configuration information. The constraints can be contained all in the templates, or provided in addition to the templates, to further limit the number of options for the grounded model.

### FIG. 12, Application Performance Model

The purpose of the Application Performance Model is to define the resource demands for each BPStep. There are two types of resource demand to consider.
1. The demand for resources generated directly by the ApplicationExecutionComponent (e.g. Dialog WP) using CPU, storage I/O, network I/O and memory when it executes the BPStep—the ComponentResourceDemand
2. The demand for resources generated by components that the above ApplicationExecutionComponent causes when it uses, calls or invokes other components (e.g. a Dialog WP using an Update WP)—the IndirectComponentResourceDemand

The IndirectComponentResourceDemand is recursive. So there will be a tree like a call-graph or activity-graph.

A complete Application Performance Model would contain similar information for all the BPSteps shown in FIG. 11. For example the set of dialog steps in the BPStep “Create Sales Order” might consume 0.2 SAPS. Further it consists of 4 separate invocations (or in SAP terminology Dialog Steps). The calls are synchronous.

The following are some examples of attributes that can appear in IndirectComponentResourceDemands and ComponentResourceDemands.
delayProperties: Any delay (e.g. wait or sleep) associated with the component's activity which does not consume any CPU, NetIOProperties and DiskIOProperties.
Numinvocation: The number of times the component is called during the execution of the BPStep.
InvocationType: synchronous if the caller is blocked; asynchronous if the caller can immediately continue activity.
BPStepToAppCompID: This is the ID attribute of the BPStepToApplicationComponentMapping. The reason for this is that a particular ApplicationExecutionComponent is likely to be involved in several different BPSteps.
ApplicationEntryPoint: This is the program or function being executed. In the case of “Create Sales Order” this is VAO1 for the DialogWP. It could also be a method of a Web Service.

CPUProperties can be expressed in SAPs or in other units. There are various ways to express MemProperties, NetIOProperties and DiskIOProperties.

### FIG. 12, Component Performance Model

There is one instance of an Application Performance Model for each instance of a Custom Model. This is because, in the general case, each business process will have unique characteristics: a unique ordering of BPSteps and/or a unique set of data characteristics for each BPStep. The DirectComponentResourceDemands and IndirectComponentResourceDe-mands associations specify the unique resource demands for each BPStep. These demands need to be calculated from known characteristics of each ApplicationComponent derived from benchmarks and also traces of installed systems.

The Component Performance Model contains known performance characteristics of each ApplicationComponent. A specific Application Performance Model is calculated by combining the following:
The information contained in the BPStepToApplicationComponentMapping associations in the Custom Model
Any performance related constraints in the Application Constraints Model
The Component Performance Model

Taken together, the models of the Unbound Model specify not only the non-functional requirements of a system, but also a recipe for how to generate and evaluate possible software and hardware configurations that meet those requirements. The generation of possible hardware configurations is constrained by the choice of infrastructure available from a specific Infrastructure Provider, using information in an Infrastructure Capability Model, and by the selected template.

A general principle that applies to deployable software elements described in the Unbound Model, such as the ApplicationExecutionComponent or ApplicationExecutionService, is that the model contains only the minimum number of instances of each type of element necessary to describe the structure of the application topology. For example, in the case of SD only a single instance of a Dialog Work Process ApplicationExecutionComponent associated with a single instance of an Application Server ApplicationExecutionService is needed in the Unbound Model to describe the myriad of possible ways of instantiating the grounded equivalents of both elements in the Grounded Model. It is the template and packaging information that determines exactly how these entities can be replicated and co-located.

### The Infrastructure Capability Model

As discussed above, two notable features of the modelling philosophy described are:

1. Present a template having a finite catalogue of resources that can be instantiated, so that there are a fixed and finite number of choices. For example, small-xen-vm 1-disk, medium-xen-vm 2-disk, large-xen-vm 3-disk, physical-hpux-machine etc. This makes the selection of resource type by any capacity planning tool simpler. It also makes the infrastructure management easier as there is less complexity in resource configuration—standard templates can be used.
2. Do not expose the hosting relationship for virtualized resources. The DMTF Virtualization System Profile models hosting relationship as a “HostedDependency” association. This does not seem to be required if there is only a need to model a finite number of resource types, so it does not appear in any of the models discussed here. This keeps the models simpler since there is no need to deal with arbitrary recursion. It does not mean that tools that process these models can't use the DMTF approach internally if that is convenient. It may well be convenient for a Resource Directory Service and Resource Assignment Service to use this relationship in their internal models.

An instance of an infrastructure capability model contains one instance for each type of ComputerSystem or Device that can be deployed and configured by the underlying utility computing fabric. Each time the utility deploys and configures one of these types the configuration will always be the same. For a ComputerSystem this means the following.
Same memory, CPU, Operating System
Same number of NICs with same I/O capacity
Same number of disks with the same characteristics

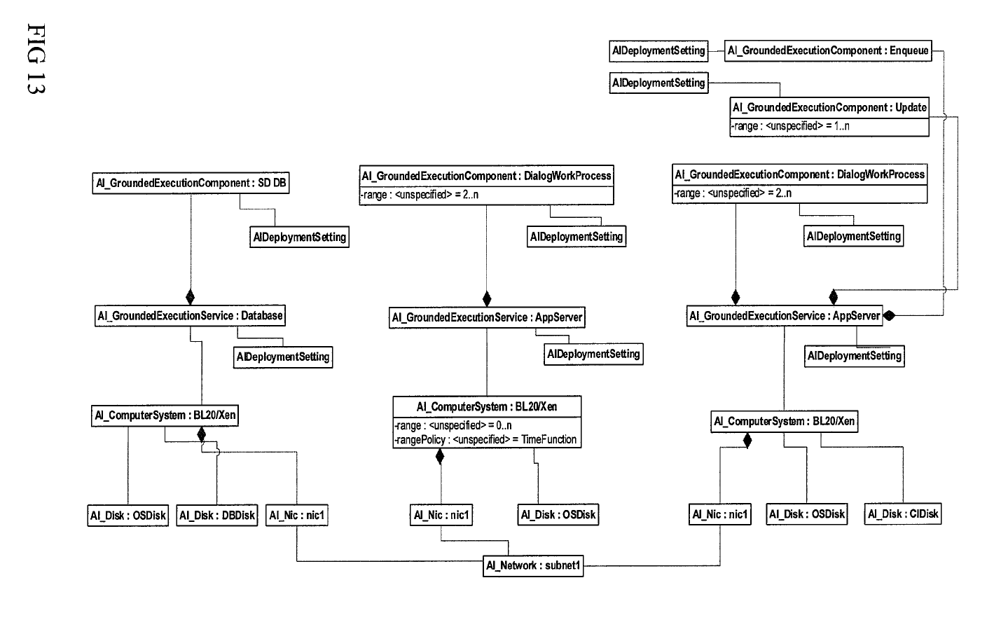

### FIG. 13 Template Example

FIG. 13 shows an example of an infrastructure design template having predetermined parts of the computing infrastructure, predetermined relationships between the parts, and having a limited number of options to be completed. In this case it is suitable for a decentralised SD business process, without security or availability features. The figure shows three computer systems coupled by a network labelled “AI network”, the right hand of the three systems corresponding to a master application server, and the central one corresponds to slave application servers as shown in FIG. 7. Hence it is decentralized. AI is an abbreviation of Adaptive Infrastructure. The left hand one of the computer systems is for a database. The type of each computer system is specified, in this case as a BL20/Xen. The central one, corresponding to slave application servers has an attribute “range=0 . . . n”. This means the template allows any number of these slave application servers.

The master application server is coupled to a box labelled AI_GroundedExecutionService:AppServer, indicating it can be used to run such a software element. It has an associated AIDeploymentSetting box which contains configuration information and deployment information sufficient to allow the AI_GroundedExecutionService to be automatically installed, deployed and managed. The AI_GroundedExecutionService:AppServer is shown as containing three components, labelled AI_GroundedExecutionComponents, and each having an associated AIDeploymentSetting box. A first of these components is a dialog work process, for executing the application components of steps of the business process, another is an update process, responsible for committing work to persistent storage, and another is an enqueue process, for managing locks on a database. As shown, the range attribute is 2 . . . n for the update and the dialog work process, meaning multiple instances of these parts are allowed.

The slave application server has a GroundedExecutionService having only one type of AI_GroundedExecutionComponent for any number of dialog work processes. The slave application server is shown having a rangeP=Time function, meaning it is allowed to be active at given times. Again the service and the execution component each have an associated AIDeploymentSetting box.

The master and slave application servers and the database computer system have an operating system shown as AI_disk: OSDisk. The master application server is shown with an AI_Disk: CIDisk as storage for use by the application components. For the network, each computer system has a network interface shown as AI_Nic1, coupled to the network shown by AI_Network: subnet1.

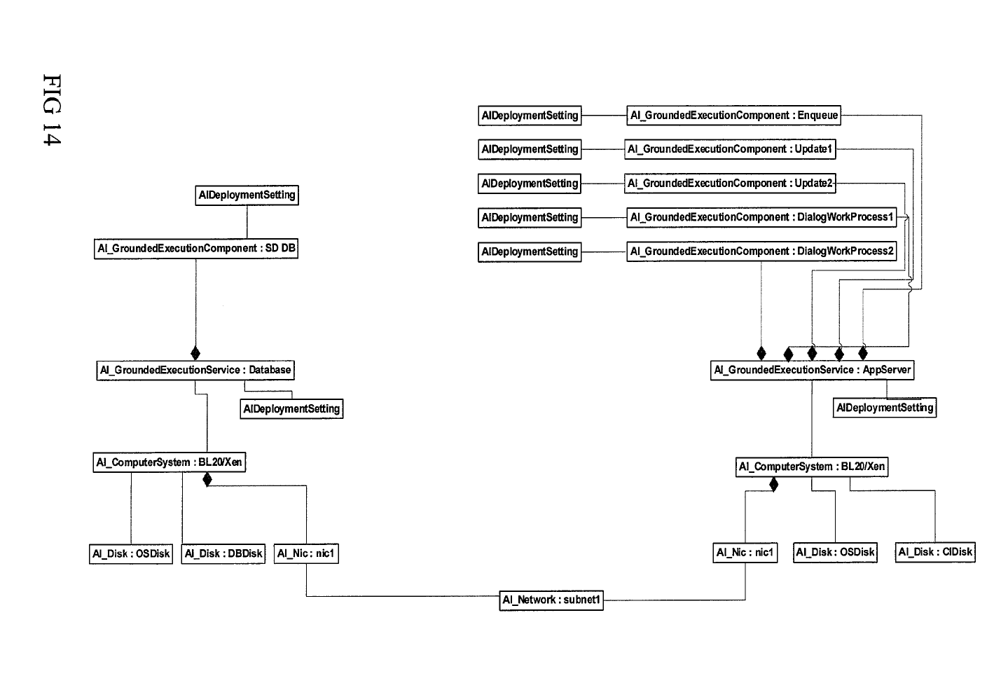

The database computer system is coupled to a box labelled AI_GroundedExecutionService: Database, which has only one type of AI_GroundedExecutionComponent, SD DB for the database. Again the service and the execution component each have an associated AIDeploymentSetting box. AIDeploymentSetting carries the configuration and management information used to deploy, configure, start, manage and change the component. Further details of an example of this are described below with reference to FIG. 14. This computer system is coupled to storage for the database labelled AI_Disk: DBDisk.

Optionally the template can have commands to be invoked by the tools, when generating the grounded model, or generating a changed grounded model to change an existing grounded model. Such commands can be arranged to limit the options available, and can use as inputs, parts of the template specifying some of the infrastructure design. They can also use parts of the unbound model as inputs.

### FIG. 14 Grounded Model

The Grounded Model may be generated by a design tool as it transforms the Unbound Model into the Grounded Model. It can be regarded as a candidate Grounded Model until evaluated and selected as the chosen Grounded Model. The following are some of the characteristics of the example Grounded Model of FIG. 14 compared to the template shown in FIG. 13, from which it is derived.
The number of instances of GroundedExecutionComponent has been specified.
The GroundedExecutionComponents are executed by a GroundedExecutionService. The execution relationship is consistent with that expressed in the Application Packaging Model.
The GroundedExecutionServices are run on a ComputerSystem whose type has been selected from the Infrastructure Capability Model.
There are two update components, Update1 and Update2. There are two DialogWorkProcesses, DialogWorkProcess1 and DialogWorkProcess2.
The number of slave application servers has been set at zero.

The management system is arranged to make these choices to derive the Grounded Model from the template using the Unbound Model. In the example shown, the criteria used for the choice includes the total capacity of the system, which must satisfy the time varying Performance Requirements in the Custom Model. The required capacity is determined by combining these Performance Requirements with the aggregated ResourceDemands [Direct and Indirect] of the Application Performance Model. If the first choice proves to provide too little capacity, or perhaps too much, then other choices can be made and evaluated. Other examples can have different criteria and different ways of evaluating how close the candidate grounded model is to being a best fit.

In some examples the server may only have an OS disk attached; that is because the convention in such installations is to NFS mount the CI disk to get its SAP executable files. Other example templates could have selectable details or options such as details of the CIDisk and the DBDisk being 100 GB, 20 MB/sec, non Raid, and so on. The OS disks can be of type EVA800. The master and slave application servers can have 2 to 5 dialog work processes. Computer systems are specified as having 3 GB storage, 2.6 GHz CPUs and SLES 10-Xen operating system for example. Different parameters can be tried to form candidate Grounded Models which can be evaluated to find the best fit for the desired performance or capacity or other criteria.

The Grounded Model therefore specifies the precise number and types of required instances of software and hardware deployable entities, such as GroundedExecutionComponent, GroundedExecutionService, and AIComputerSystem. AIDeploymentSettings can include for example:
InfrastructureSettings such as threshold information for infrastructure management components, for example MaxCPUUtilization—if it rises above the set figure, say 60%, an alarm should be triggered.
Management policy can specify further policy information for the management components—e.g. flex up if utilization rises above 60%
GroundedDeploymentSettings which can include all command line and configuration information so that the system can be installed, configured and started in a fully functional state.
SettingData which can provide additional configuration information that can override information provided in the GroundedDeploymentSettings. This allows many

GroundedComponents to share the same GroundedDeploymentSettings (c.f. a notion of typing) with specific parameters or overrides provided by SettingData. Both the GroundedDeploymentSettings and SettingData are interpreted by the Deployment Service during deployment.
Data related to possible changes to the component such as instructions to be carried out when managing changes to the component, to enable more automation of changes.

Not all attributes are set in the Grounded Model. For example, it does not make sense to set MAC addresses in the Grounded Model, since there is not yet any assigned physical resource.

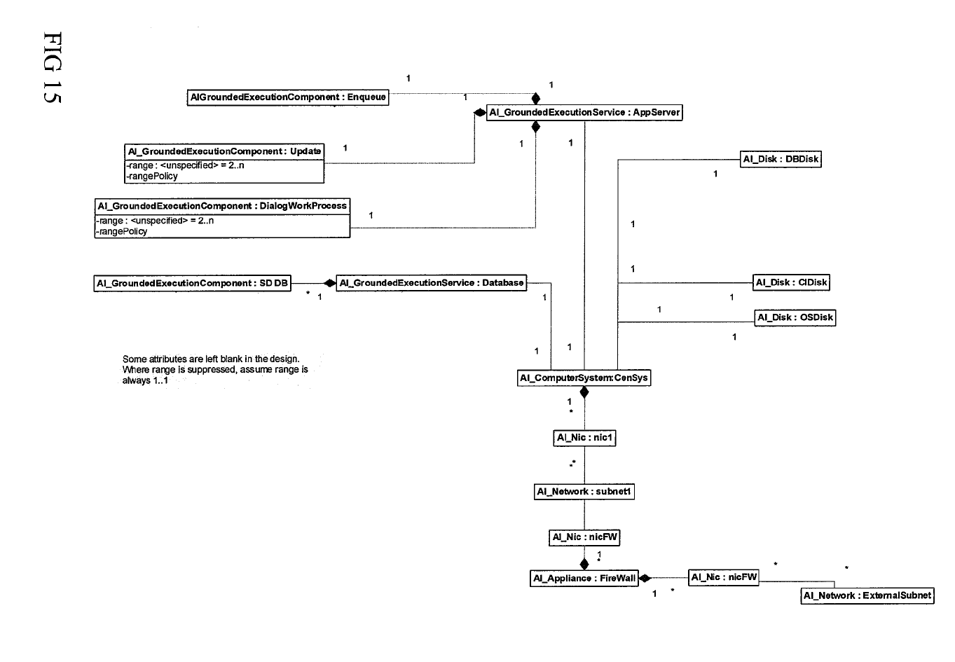

### FIG. 15, an Alternative Adaptive Infrastructure Design Template

FIG. 15 shows an alternative adaptive infrastructure design template, in a form suitable for a centralised secure SD business process. Compared to FIG. 13, this has only one computer system, hence it is centralised. It shows security features in the form of a connection of the network to an external subnet via a firewall. This is shown by an interface AI_Nic:nicFW, and a firewall shown by AI_Appliance: FireWall.

Other templates can be envisaged having any configuration. Other examples can include a decentralised secure SD template, a decentralised highly available SD template, and a decentralised, secure and highly available SD template.

### Bound Model

A Bound Model Instance for a SD system example could have in addition to the physical resource assignment, other parameters set such as subnet masks and MAC addresses. A Deployed Model could differ from the Bound Model in only one respect. It shows the binding information for the management services running in the system. All the entities would have management infrastructure in the form of for example a management service. The implementation mechanism used for the interface to the management services is not defined here, but could be a reference to a Web Service or a SmartFrog component for example. The management service can be used to change state and observe the current state. Neither the state information made available by the management service, nor the operations performed by it, are necessarily defined in the core of the model, but can be defined in associated models.

One example of this could be to manage a virtual machine migration. The application managing the migration would use the management service running on the PhysicalComputerSystem to do the migration. Once the migration is completed, the management application would update the deployed model and bound models to show the new physical system. Care needs to be taken to maintain consistency of models. All previous model instances are kept in the model repository, so when the migration is complete, there would be a new instance (version) of the bound and deployed models.

### Information Hiding and the Model Information Flow

It is not always the case that for the MIF all tools and every actor can see all the information in the model. In particular it is not the case for deployment services having a security model which requires strong separation between actors. For example, there can be a very strong separation between the utility management plane and farms of virtual machines. If a grounded model is fed to the deployment services of the management plane for an enterprise, it will not return any binding information showing the binding of virtual to physical machines, that information will be kept inside the management plane. That means there is no way of telling to what hardware that farm is bound or what two farms might be sharing. What is returned from the management plane could include the IP address of the virtual machines in the farms (it only deals with virtual machines) and the login credentials for those machines in a given farm. The management plane is trusted to manage a farm so that it gets the requested resources. Once the deployment service has finished working, one could use application installation and management services to install, start and manage the applications. In general different tools will see projections of the MIF. It is possible to extract from the MIF models the information these tools require and populate the models with the results the tools return. It will be possible to transform between the MIF models and the data format that the various tools use.

### Implementation:

The software parts such as the models, the model repository, and the tools or services for manipulating the models, can be implemented using any conventional programming language, including languages such as Java, or C compiled following established practice. The servers and network elements can be implemented using conventional hardware with conventional processors. The processing elements need not be identical, but should be able to communicate with each other, e.g. by exchange of IP messages.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles behind the invention and its practical applications to enable one skilled in the art to utilize the invention in various embodiments and with various modifications as are suited to the particular use contemplated. Other variations can be conceived within the scope of the claims.

1. A method of generating a model representing at least part of a computer based business process having a number of functional steps, from existing source content specifying the functional steps, and from source content of software entities implementing the functional steps, the source content having annotations added, to provide information for modelling, the method having the steps of:
collecting the information provided by the annotations, and
using the information collected by the collector, to generate representations of the functional steps and software entities which implement the functional steps, and arranged to incorporate these representations in the model.

2. The method of claim 1, having the step of generating for the model a representation of demands on computing infrastructure by the software entities.

3. The method of claim 1, at least some of the annotations being descriptive annotations having statically determinable information identifying the functional steps and software entities for implementing the functional steps, and the method having the step of reading the source content to collect the information.

4. The method of claim 3, the descriptive annotations using types of entities and types of relationships where the types correspond to types used in the model.

5. The method of claim 1, at least some of the annotations being monitoring annotations arranged to modify run-time behaviour of the business process to generate information relating to run-time behaviour, and the method having the step of collecting the information relating to run-time behaviour.

6. The method of claim 5, having the step of using the collected run-time behaviour information, to generate a representation of demands on the computing infrastructure by the software entities.

7. The method of claim 6, having the step of correlating the collected information on run-time behaviour with corresponding representations of software entities and functional steps in the model.

8. The method of claim 5, a level of detail of the monitoring of run-time behaviour being configurable.

9. The method of claim 1, having a documentation generator, arranged to generate human readable documentation relating to the functional steps and the software entities for implementing the functional steps, from the information collected.

10. The method of claim 1, the model comprising an unbound model, and a grounded model, having the step of using the annotations to generate the unbound model, and generating a mapping of logical components of the unbound model on to computing infrastructure, to provide a grounded model of the business process, suitable for automated deployment on the computing infrastructure.

11. Software on a machine readable medium which when executed carries out the method of claim 1.

12. A system for generating a model representing at least part of a computer based business process having a number of functional steps, from existing source content specifying the functional steps, and from source content of software entities implementing the functional steps, the source content having annotations added, to provide information for modelling, the system having:
a collector arranged to collect the information provided by the annotations, and a modeller arranged to use the information collected by the collector, to generate representations of the functional steps and software entities which implement the functional steps, and arranged to incorporate these representations in the model.

13. The system of claim 12, the modeller being arranged to generate for the model a representation of demands on computing infrastructure by the software entities.

14. The system of claim 12, at least some of the annotations being descriptive annotations having statically determinable information identifying the functional steps and software entities for implementing the functional steps, and the collector being arranged to read the source content to collect the information.

15. The system of claim 14, the descriptive annotations using types of entities and types of relationships where the types correspond to types used in the model.

16. The system of claim 12, at least some of the annotations being monitoring annotations arranged to modify run-time behaviour of the business process to generate information relating to run-time behaviour, and the collector being arranged such that at least some of the information collected by the collector is the information relating to run-time behaviour.

17. The system of claim 16, the modeller being arranged to use the collected run-time behaviour information, to generate a representation of demands on the computing infrastructure by the software entities.

18. The system of claim 17, the modeller being arranged to correlate the collected information on run-time behaviour with corresponding representations of software entities and functional steps in the model.

19. The system of claim 16, a level of detail of the monitoring of run-time behaviour being configurable.

20. The system of claim 12, having a documentation generator, arranged to generate human readable documentation relating to the functional steps and the software entities for implementing the functional steps, from the information collected.

21. The system of claim 12, the model comprising an unbound model, and a grounded model, the modeller being arranged to generate the unbound model, and the system further having a design service to generate a mapping of logical components of the unbound model on to computing infrastructure, to provide a grounded model of the business process, suitable for automated deployment on the computing infrastructure.
